(19) United States
(12) Patent Application Publication
(10) Pub. No.: US 2026/0005942 A1
(43) Pub. Date: Jan. 1, 2026

(54) REMOTE CONTROL APPARATUS, AND METHOD OF REMOTELY CONTROLLING MOBILE OBJECT

(71) Applicant: Mitsubishi Electric Corporation, Tokyo (JP)

(72) Inventors: Shota KAMEOKA, Tokyo (JP); Yohei HOSOE, Kyoto (JP)

(73) Assignee: Mitsubishi Electric Corporation, Tokyo (JP)

(21) Appl. No.: 18/879,675

(22) PCT Filed: Jul. 6, 2022
(86) PCT No.: PCT/JP2022/026822

§ 371 Date: Dec. 27, 2024

(51) Int. Cl. H04L 43/0852; G05D 1/226; G05D 1/227; H04L 67/12

(52) U.S. Cl. CPC H04L 43/0852; G05D 1/226; G05D 1/2274; H04L 67/12

(57) ABSTRACT

A remote control apparatus controls at least one mobile object, and includes: a transmission latency distribution estimation unit estimating transmission latency distribution information based on transmission latency information of a transmission path obtained in advance and transmission latency information obtained online, the transmission latency distribution information including a time-changed probability distribution of transmission latencies; a trajectory generating unit generating a target trajectory of the mobile object, based on surrounding information around the mobile object; and a mobile object control unit generating a controlled amount of the mobile object, based on the transmission latency distribution information, the target trajectory, and mobile object information, wherein the mobile object control unit includes: a gain setting unit setting a control gain, based on the transmission latency distribution information; and a controlled amount computation unit generating the controlled amount, based on the target trajectory, the control gain, and the mobile object information.

### TECHNICAL FIELD

The present disclosure relates to a remote control apparatus that controls one or more mobile objects through a network, and to a remote control apparatus that considers transmission latencies.

### BACKGROUND ART

Recent years have seen development of remote control apparatuses each implementing autonomous driving such as automated valet parking, and automatic transfer by transmitting and receiving data to and from a mobile object in a remote location. The data is transmitted and received through a network including radio communication and the Internet. Here, transmission latencies occur in transmitting and receiving the data due to, for example, a distance and an obstacle between a remote control apparatus and the mobile object. An attempt to control the mobile object under this environment may make the mobile object unstable.

Patent Document 1 discloses a method of stably controlling a mobile object by assuming transmission latencies as random variables and designing a control gain based on a probability distribution of the transmission latencies.

### PRIOR ART DOCUMENT

### Patent Document

Patent Document 1: Japanese Patent No. 6940036

### Non-Patent Documents

Non-Patent Document 1: Yohei Hosoe et al., “On second moment stability of discrete-time linear systems with general stochastic dynamics”, IEEE Trans. Automatic Control, 2021
Non-Patent Document 2: Daiki Takita, Yohei Hosoe, Tomomichi Hagiwara, “Stabilization of Discrete-Time Linear Systems with Stochastic Dynamics Determined by a Hidden Markov Model”, The 9th SICE Multi-Symposium on Control Systems, 2022

### SUMMARY

### Problem to be Solved by the Invention

In Patent Document 1, however, the control gain has been designed under a hypothesis that a probability distribution of transmission latencies does not change with time, that is, the probability distribution is invariant with time (time-invariant) and a hypothesis that values are not time-dependent. These hypotheses are that transmission latencies mathematically follow an independent and identical distribution (abbreviated hereinafter as i.i.d.) with time, and produce an advantage of simplifying designing of the control gain by making the transmission latencies relatively simple when mathematically manipulated. In Patent Document 1, when the transmission latencies satisfy this condition, the stability can be guaranteed.

When probability distributions followed by respective random variables, that is, when marginal probabilities are identical and independent, it is said that the random variables follow the independent and identical distribution. Thus, a distribution named the “independent and identical distribution” does not exist.

These hypotheses hold in a small-scaled network, that is, when a frequency of changing path control on packets is low and when network users are small-scaled. However, paths of packets are frequently changed when large-scaled networks such as the Internet are used. Here, a hypothesis that a probability distribution is changed with time (may be hereinafter described as time-changed), that is, a hypothesis that a probability distribution is an i.i.d. with time does not hold.

Although Patent Document 1 describes that “a distribution of transmission latencies may be estimated, or estimated online while remotely controlled”, Patent Document 1 fails to describe the specific method.

The present disclosure has an object of providing a remote control apparatus that suppresses an unstable behavior of a mobile object even under a large-scaled network environment.

### Means to Solve the Problem

A remote control apparatus controlling at least one mobile object through a transmission path including at least a network, the apparatus including: a transmission latency distribution estimation unit to estimate transmission latency distribution information including a time-changed probability distribution of transmission latencies, the transmission latencies being estimated based on transmission latency information of the transmission path obtained in advance and transmission latency information obtained online; a trajectory generating unit to generate a target trajectory of the at least one mobile object, based on surrounding information around the at least one mobile object; and a mobile object control unit to generate a controlled amount of the at least one mobile object, based on the transmission latency distribution information obtained from the transmission latency distribution estimation unit, the target trajectory obtained from the trajectory generating unit, and mobile object information obtained from the at least one mobile object, wherein the mobile object control unit includes: a gain setting unit to set a control gain, based on the transmission latency distribution information; and a controlled amount computation unit to generate the controlled amount, based on the target trajectory, the control gain, and the mobile object information.

### Effects of the Invention

The remote control apparatus according to the present disclosure can remotely control a mobile object with an unstable behavior being suppressed, even under a transmission latency environment.

### BRIEF DESCRIPTION OF DRAWINGS

FIG. 1 is a block diagram illustrating a configuration of a remote control apparatus and a remote control system in Embodiment 1 according to the present disclosure.

FIG. 2 is a block diagram illustrating a configuration of a remote control apparatus and a remote control system in Embodiment 1 according to the present disclosure.

FIG. 3 is a block diagram illustrating a configuration of a first mobile object control unit.

FIG. 4 is a block diagram illustrating a configuration of the first mobile object control unit.

FIG. 5 is a block diagram illustrating a configuration of the first mobile object.

FIG. 6 illustrates an example structure of the first mobile object when the first mobile object is a vehicle.

FIG. 7 illustrates example placement of object information obtainment units.

FIG. 8 illustrates a target path along which the first mobile object avoids a stop object.

FIG. 9 illustrates example placement of an object information obtainment unit and an environment information obtainment unit.

FIG. 10 illustrates an example target speed to be generated by the remote control apparatus in Embodiment 1 according to the present disclosure.

FIG. 11 illustrates an example method for a trajectory generating unit to generate target trajectories of two or more mobile objects.

FIG. 12 illustrates an example method for the trajectory generating unit to generate target trajectories of two or more mobile objects.

FIG. 13 is a block diagram illustrating an example configuration of the transmission latency distribution estimation unit.

FIG. 14 illustrates an example time series of transmission latencies.

FIG. 15 illustrates an example modeled by the HMM.

FIG. 16 is a block diagram illustrating an example control system that controls the first mobile object under a transmission latency environment including the remote control apparatus in Embodiment 1 according to the present disclosure.

FIG. 17 illustrates an example target path when the first mobile object is a vehicle.

FIG. 18 is a block diagram illustrating a configuration of a remote control apparatus and a remote control system in Embodiment 2 according to the present disclosure.

FIG. 19 is a block diagram illustrating an example configuration of the transmission latency distribution estimation unit.

FIG. 20 is a block diagram illustrating an example configuration of the transmission latency distribution estimation unit in a remote control apparatus of Embodiment 4 according to the present disclosure.

FIG. 21 illustrates a hardware configuration that implements a remote control apparatus.

FIG. 22 illustrates a hardware configuration that implements a remote control apparatus.

### DESCRIPTION OF EMBODIMENTS

### Embodiment 1

### [Overall Configuration]

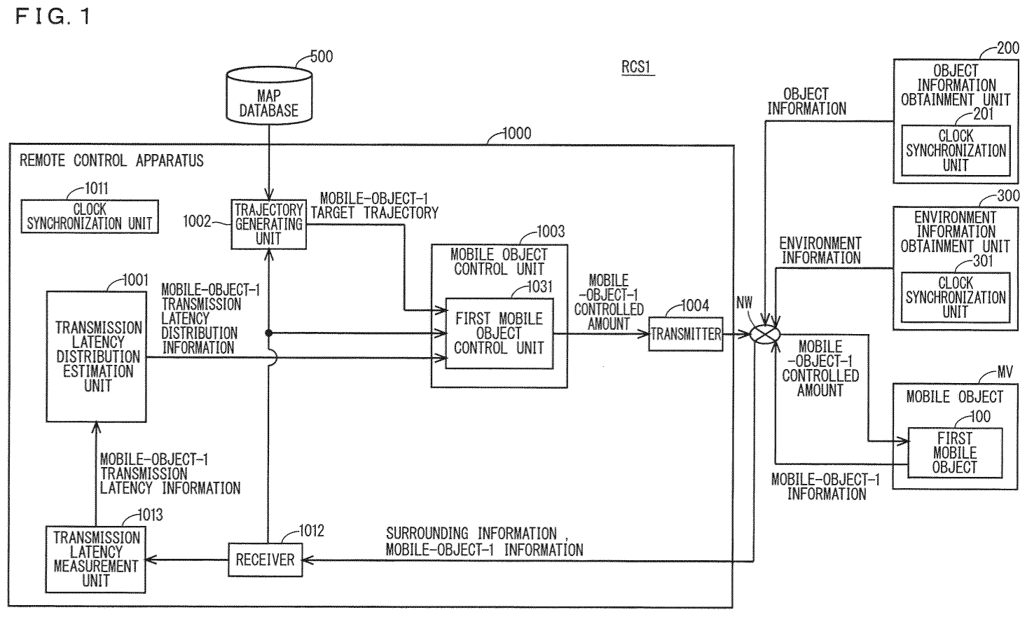

FIG. 1 is a block diagram illustrating an example configuration of a remote control apparatus 1000, and a configuration of a remote control system RCS1 for a mobile object MV to be remotely controlled through a network NW, in Embodiment 1 according to the present disclosure.

As illustrated in FIG. 1, the remote control system RCS1 has the configuration in which the mobile object MV, the remote control apparatus 1000, an object information obtainment unit 200, and an environment information obtainment unit 300 are connected to the network NW. A map database is connected to the remote control apparatus 1000.

The network NW enables a plurality of constituent elements to transmit and receive data by mutually connecting the elements through, for example, cables and radio waves. The network NW includes a local area network (LAN), a wide area network (WAN), the Internet, telephone lines, and radio communication. The network NW is not limited to these, and can employ any means that enables transmission and reception of data between a remote control apparatus and a mobile object in a remote location.

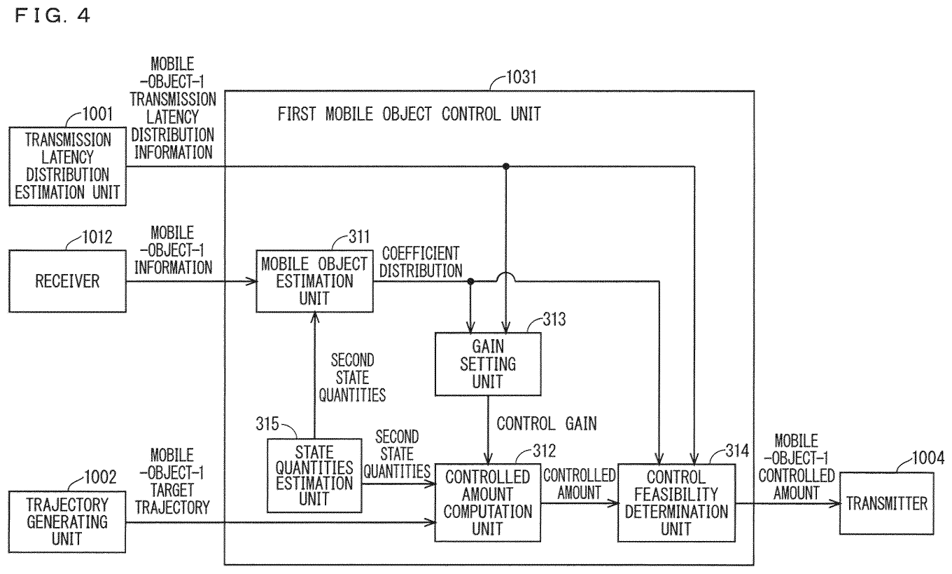

Since a single mobile object is a control target in Embodiment 1, the mobile object MV will be referred to as a first mobile object 100 to be distinguished from a plurality of mobile objects as control targets. The first mobile object 100 moves based on a controlled amount to be transmitted from a transmitter 1004 of the remote control apparatus 1000, and outputs a state quantity of this mobile object which has been detected by the internal sensors (to be described later) including, for example, a speed sensor mounted, as state information on the first mobile object 100, that is, mobile-object-1 information. A configuration of the first mobile object 100 will be described later in detail with reference to FIG. 4.

The object information obtainment unit 200 includes one or more sensors in the vicinity of the first mobile object 100 or to be mounted on the first mobile object 100. The object information obtainment unit 200 is installed in, for example, a traffic light, a utility pole, or an electric lamp at an intersection when the mobile object is an automobile and travels along a road. Furthermore, the object information obtainment unit 200 may be additionally installed on a roadside. For other mobile objects, for example, a mobile object moving indoors, the object information obtainment units may be installed on a ceiling and a wall. The object information obtainment unit 200 obtains, as object information, for example, a position and a speed of an obstacle around the first mobile object 100, such as another vehicle, a bicycle, and a pedestrian. Furthermore, the object information obtainment unit 200 can obtain, as mobile object information, for example, a position and a speed of its own first mobile object 100. Here, the mobile object information is a part of the object information. The object information obtainment unit 200 transmits the mobile object information to a receiver 1012 in the remote control apparatus 1000 through the network NW. When internal sensors are installed in the first mobile object 100, these internal sensors can obtain the mobile object information. Here, the mobile object information corresponds to the mobile-object-1 information. Thus, the mobile object information can be obtained from the object information obtainment unit 200 or the first mobile object 100.

The object information obtainment unit 200 includes a clock synchronization unit 201. The clock synchronization unit 201 has a function of synchronizing the timing of transmitting and receiving data in coordination with a clock synchronization unit in the first mobile object 100 which is not illustrated, a clock synchronization unit 310 in the environment information obtainment unit 300, and a clock synchronization unit 1011 in the remote control apparatus 1000.

Each of the clock synchronization units can perform clock synchronization outdoors, using a Global Navigation Satellite System (GNSS) sensor. Since the GNSS is a clock synchronization system at global levels and relates to a known art, this GNSS can facilitate the clock synchronization. Meanwhile, indoor clock synchronization is possible by accessing a Network Time Protocol (NTP) server installed on the network NW.

The environment information obtainment unit 300 includes one or more sensors to be installed in the vicinity of the first mobile object 100, similarly to the object information obtainment unit 200. The environment information obtainment unit 300 is also installed indoors or outdoors. The environment information obtainment unit 300 obtains environment information on, for example, a traffic light and a stop line. The environment information obtainment unit 300 transmits the environment information to the receiver 1012 in the remote control apparatus 1000 through the network NW. The object information obtainment unit 200 can sometimes obtain the environment information. In all subsequent Embodiments, the object information and the environment information will be collectively referred to as surrounding information. When, for example, a mobile object is a robot, the surrounding information may be solely object information without including environment information. Furthermore, the sensor to be used for the environment information obtainment unit 300 can be mounted on the first mobile object 100.

The environment information obtainment unit 300 includes the clock synchronization unit 301. The clock synchronization unit 301 has a function of synchronizing the timing of transmitting and receiving data in coordination with the clock synchronization unit in the first mobile object 100 which is not illustrated, the clock synchronization unit 201 in the object information obtainment unit 200, and the clock synchronization unit 1011 in the remote control apparatus 1000.

Examples of the sensors to be used in the object information obtainment unit 200 and the environment information obtainment unit 300 include a camera, a light detection and ranging (LiDAR), and a radar.

The camera is installed at a position where a front image, a side image, and a rear image can be captured, and obtains, from the captured images, for example, dividing lines and a position and a speed of an obstacle around the first mobile object 100.

The LiDAR emits a laser beam to the surroundings and detects a time difference from when the laser beam is reflected off from a surrounding object until the beam comes back to detect a position of the object.

The radar emits radar waves to the surroundings and detects the reflected waves to measure a relative distance and a relative speed of a surrounding obstacle with respect to the radar, and outputs the measurement result.

When each obstacle mounts a GNSS sensor that can detect an absolute position of, for example, an obstacle around the first mobile object 100, and when the first mobile object 100 mounts a GNSS sensor and the GNSS sensor can transmit absolute position information to the remote control apparatus 1000 through the network NW, the GNSS enables detection of the object information. In such a case, the object information obtainment unit 200 can be omitted.

A map database 500 stores map data around the first mobile object 100. Although a trajectory generating unit 1002 is connected to the map database 500 in FIG. 1, besides this, each of the constituent elements in the remote control apparatus 1000 can access the map database 500. When the first mobile object 100 is a vehicle, the map database 500 often includes traveling data, for example, center coordinate information on roads, information on stop lines, information on white lines, and traveling possible regions.

### [Remote Control Apparatus]

Next, each of the constituent elements of the remote control apparatus 1000 will be described. As illustrated in FIG. 1, the remote control apparatus 1000 includes a transmission latency distribution estimation unit 1001, the trajectory generating unit 1002, the mobile object control unit 1003, the transmitter 1004, the clock synchronization unit 1011, the receiver 1012, and a transmission latency measurement unit 1013.

The clock synchronization unit 1011 has a function of synchronizing the timing of transmitting and receiving data in coordination with the clock synchronization unit in the first mobile object 100 which is not illustrated, the clock synchronization unit 201 in the object information obtainment unit 200, and the clock synchronization unit 301 in the environment information obtainment unit 300.

The receiver 1012 receives object information from the object information obtainment unit 200, environment information from the environment information obtainment unit 300, and the mobile-object-1 information from the first mobile object 100. As described above, the surrounding information is combined information of the object information and the environment information, and is designated as SURROUNDING INFORMATION in the drawings. The mobile object information includes first state quantities, second state quantities, and time information. The first state quantities are state quantities obtained by sensors on, for example, a position, a speed, an acceleration, and an angular velocity of the first mobile object 100. The second state quantities are state quantities that are not obtained from the sensors, and are estimated by, for example, a state estimation unit to be described later. The time information includes, for example, the time synchronized by the clock synchronization unit 1011, and information for clock synchronization processes.

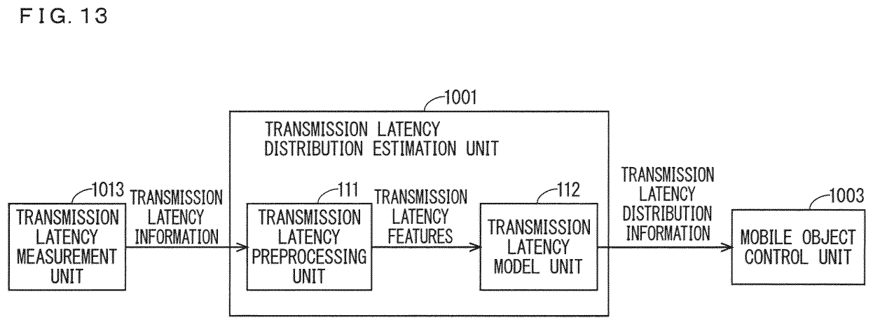

The trajectory generating unit 1002 generates a target trajectory of the first mobile object 100, that is, a mobile-object-1 target trajectory, based on the map data around the first mobile object 100 which has been obtained from the map database 500, and the surrounding information obtained through the network NW. Here, the target trajectory can be obtained by combining a target path with a target speed. Alternatively, the target trajectory can be obtained by combining a target path with a target position. Furthermore, any state quantity of the first mobile object 100 can be combined with a target path, without being limited to the target speed or the target position. The trajectory generating unit 1002 can generate a target trajectory, based on only the surrounding information. A method of generating a target trajectory by the trajectory generating unit 1002 will be described later in detail with reference to FIGS. 13 to 15.

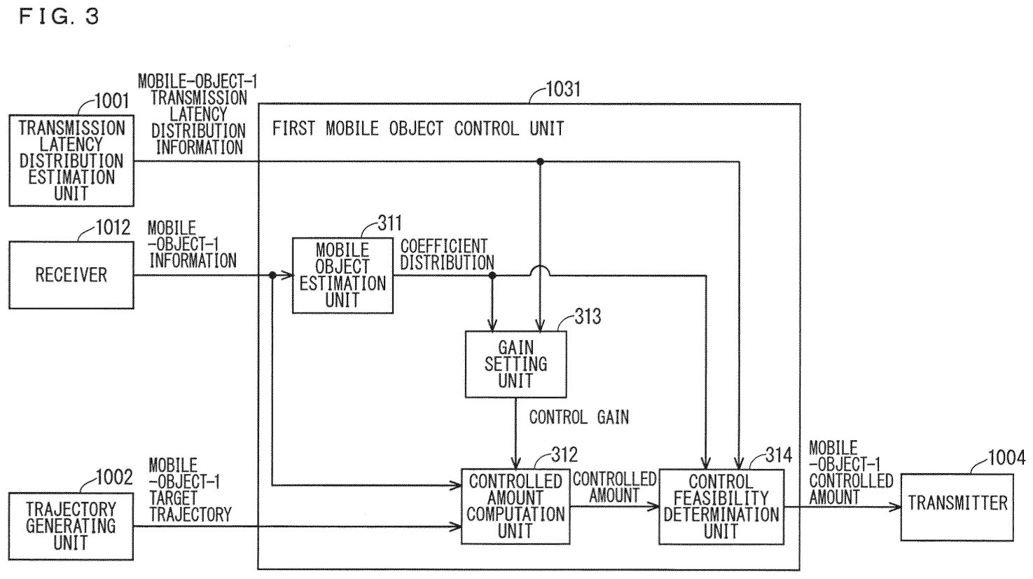

The mobile object control unit 1003 includes a first mobile object control unit 1031. The first mobile object control unit 1031 computes a controlled amount for allowing the first mobile object 100 to follow a target trajectory, based on the mobile object information obtained from the network NW through the receiver 1012 and the mobile-object-1 target trajectory obtained from the trajectory generating unit 1002. When the first mobile object 100 is a vehicle, the controlled amount is, for example, a target steering amount and a target amount of acceleration or deceleration. The first mobile object control unit 1031 outputs the controlled amount to the network NW through the transmitter 1004 as a mobile-object-1 controlled amount. The first mobile object control unit 1031 will be described later in detail with reference to FIGS. 3 and 4.

The transmission latency measurement unit 1013 measures transmission latencies between the first mobile object 100 and the remote control apparatus 1000, that is, transmission latency times using the clock synchronized by the clock synchronization unit 1011, and outputs, to the transmission latency distribution estimation unit 1001, the transmission latency times as transmission latency information on the first mobile object 100, that is, mobile-object-1 transmission latency information. The transmission latency measurement unit 1013 can obtain the transmission latency times each from a difference between a transmission time included in the mobile-object-1 information output from the first mobile object 100 and a reception time at which the remote control apparatus 1000 has received the mobile-object-1 information.

When a clock synchronization unit is installed in neither the remote control apparatus 1000 nor the first mobile object 100, the transmission latency can be measured in the following manner. In other words, first, the remote control apparatus 1000 transmits a packet to the first mobile object 100, and simultaneously records the time. Upon receipt of the packet, the first mobile object 100 simultaneously transmits the packet to the remote control apparatus 1000. Thus, the remote control apparatus 1000 can obtain the transmission latency from a difference between the reception time of the remote control apparatus 1000 and the transmission time. The transmission latency obtained in such a manner is referred to as a round-trip time (RTT). If the first mobile object 100 similarly records the times, the RTT in view of the first mobile object 100 can be obtained.

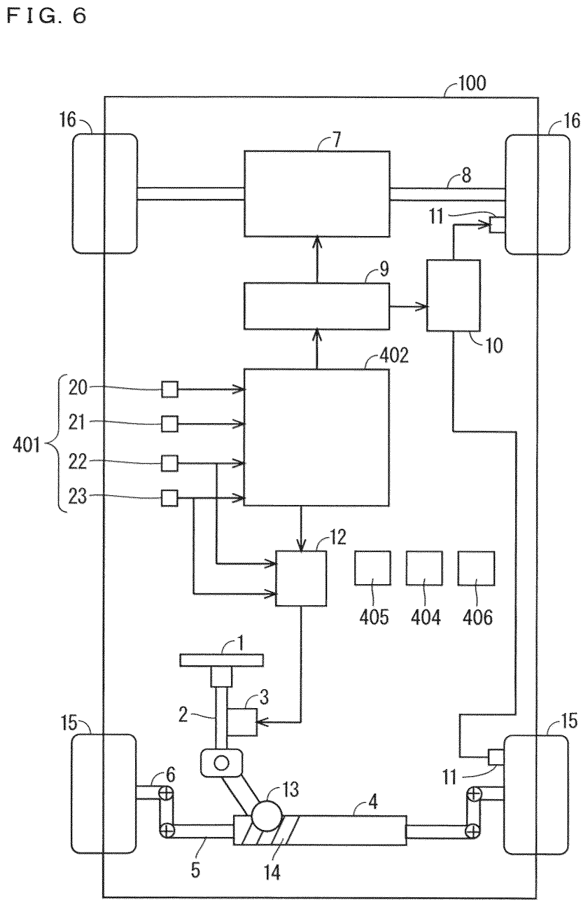

The transmission latency distribution estimation unit 1001 outputs distribution information of transmission latencies on the first mobile object 100, that is, mobile-object-1 transmission latency distribution information, using the transmission latency information from the transmission latency measurement unit 1013. The distribution information of transmission latencies is information to be estimated based on a transmission latency model such as a mode of transmission latencies, in addition to a probability distribution of transmission latencies. The configuration and operations of the transmission latency distribution estimation unit 1001 will be described later with reference to FIG. 6.

The transmitter 1004 transmits the mobile-object-1 controlled amount from the first mobile object control unit 1031 to the first mobile object 100 through the network NW.

### [Control on a Plurality of Mobile Objects]

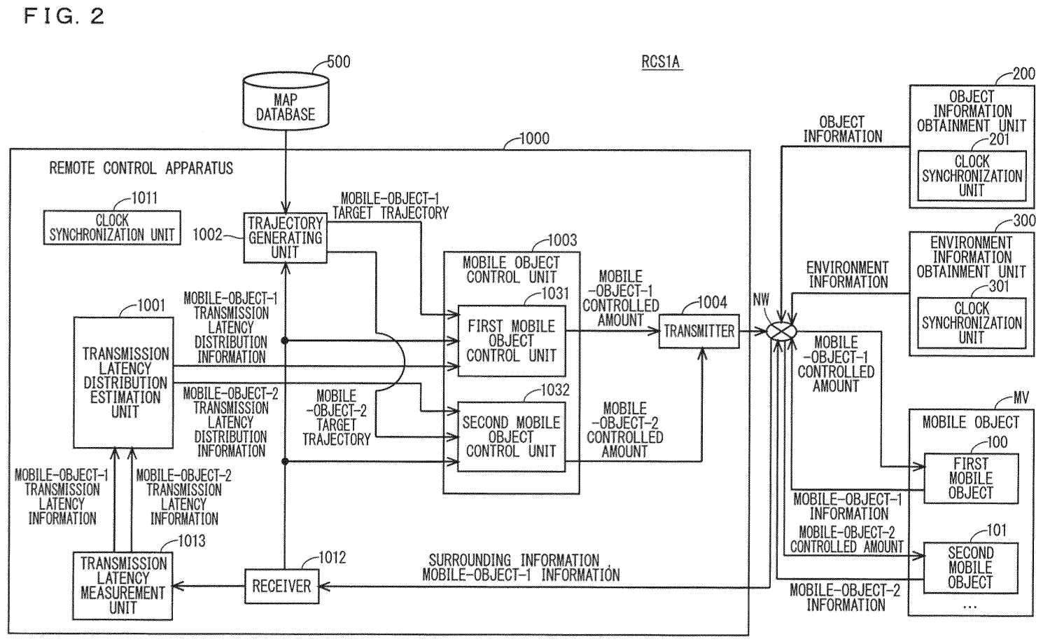

FIG. 2 is a block diagram illustrating an example configuration of the remote control apparatus 1000 and a configuration of a remote control system RCS1A for mobile objects MV to be remotely controlled through the network NW, when two or more mobile objects are controlled.

As illustrated in FIG. 2, the remote control system RCS1A has the configuration in which the mobile objects MV, the remote control apparatus 1000, the object information obtainment unit 200, and the environment information obtainment unit 300 are connected to the network NW.

The mobile object control unit 1003 in the remote control apparatus 1000 includes a first mobile object control unit 1031 and a second mobile object control unit 1032 to control a plurality of mobile objects. The mobile objects MV to be controlled are a first mobile object 100 and a second mobile object 101. In FIG. 2, the same reference numerals are used for the same configurations as those of the remote control apparatus 1000 described with reference to FIG. 1, and the overlapping description will be omitted.

The first mobile object 100 and the second mobile object 101 move based on the mobile-object-1 controlled amount and a mobile-object-2 controlled amount which are to be transmitted from the transmitter 1004 of the remote control apparatus 1000, and output state quantities of the mobile objects which have been detected by internal sensors including speed sensors mounted on the first mobile object 100 and the second mobile object 101, as the mobile-object-1 information and mobile-object-2 information, respectively.

The object information obtainment unit 200 includes one or more sensors in the vicinity of the first mobile object 100 and the second mobile object 101 or to be mounted on the first mobile object 100 and the second mobile object 101. The object information obtainment unit 200 is installed in, for example, a traffic light, a utility pole, or an electric lamp at an intersection when the mobile object is an automobile and travels along a road. Furthermore, the object information obtainment unit 200 may be additionally installed on a roadside. For other mobile objects, for example, a mobile object moving indoors, the object information obtainment units may be installed on a ceiling and a wall. The object information obtainment unit 200 obtains, as the object information, for example, positions and speeds of obstacles around the first mobile object 100 and the second mobile object 101, such as another vehicle, a bicycle, and a pedestrian. Furthermore, the object information obtainment unit 200 can obtain, for example, a position and a speed of its own first mobile object 100 as the mobile object information, and a position and a speed of its own second mobile object 101 as the mobile object information. Here, the mobile object information is a part of the object information. The object information obtainment unit 200 transmits the mobile object information to the receiver 1012 in the remote control apparatus 2000 through the network NW. When internal sensors are installed in the first mobile object 100, these internal sensors can obtain the mobile object information. When internal sensors are installed in the second mobile object 101, these internal sensors can obtain the mobile object information. Here, the mobile object information corresponds to the mobile-object-1 information and the mobile-object-2 information. Thus, the mobile object information can be obtained from the object information obtainment unit 200 or from the first mobile object 100 and the second mobile object 101.

The environment information obtainment unit 300 includes one or more sensors to be installed in the vicinity of the first mobile object 100 and one or more sensors to be installed in the vicinity of the second mobile object 101, similarly to the object information obtainment unit 200. The environment information obtainment unit 300 obtains the environment information on, for example, a traffic light and a stop line. The environment information obtainment unit 300 transmits the environment information to the receiver 1012 in the remote control apparatus 2000 through the network NW.

### [Remote Control Apparatus]

Next, each of the constituent elements of the remote control apparatus 1000 will be described. As illustrated in FIG. 2, the remote control apparatus 1000 includes the transmission latency distribution estimation unit 1001, the trajectory generating unit 1002, the mobile object control unit 1003, the transmitter 1004, the clock synchronization unit 1011, the receiver 1012, and the transmission latency measurement unit 1013.

Although these elements have functions identical to those of the remote control apparatus 1000 in FIG. 1, the transmission latency measurement unit 1013 measures transmission latencies between the first mobile object 100 and the second mobile object 101, and the remote control apparatus 1000, using the clock synchronized by the clock synchronization unit 1011, and outputs, to the transmission latency distribution estimation unit 1001, the transmission latencies as mobile-object-1 transmission latency information on the first mobile object 100 and mobile-object-2 transmission latency information on the second mobile object 101.

The mobile object control unit 1003 includes the first mobile object control unit 1031 and the second mobile object control unit 1032. The first mobile object control unit 1031 computes a controlled amount for allowing the first mobile object 100 to follow a target trajectory, that is, a mobile-object-1 controlled amount, based on the mobile-object-1 information obtained from the network NW through the receiver 1012 and the mobile-object-1 target trajectory obtained from the trajectory generating unit 1002. The second mobile object control unit 1032 computes a controlled amount for allowing the second mobile object 101 to follow a target trajectory, that is, a mobile-object-2 controlled amount, based on the mobile-object-2 information obtained from the network NW through the receiver 1012 and a mobile-object-2 target trajectory obtained from the trajectory generating unit 1002. When the number of mobile objects is three or more, the mobile object control unit 1003 has a configuration additionally including, for example, a third mobile object control unit to correspond to the number of mobile objects.

The transmission latency distribution estimation unit 1001 outputs mobile-object-1 transmission latency distribution information on the first mobile object 100 and mobile-object-2 transmission latency distribution information on the second mobile object 101, using the mobile-object-1 transmission latency information and the mobile-object-2 transmission latency information, respectively, from the transmission latency measurement unit 1013.

When considering that a plurality of mobile objects have almost equivalent network environment and surrounding circumstances, and have almost the same tendency in transmission latency, the transmission latency distribution estimation unit 1001 equates the transmission latency information on the first mobile object 100 with the transmission latency information on the second mobile object 101, groups the first mobile object 100 and the second mobile object 101, estimates a common transmission latency distribution using the transmission latency information on the first mobile object 100 or the second mobile object 101, and outputs the common transmission latency distribution to the trajectory generating unit 1002. The same holds true for the presence of three or more mobile objects.

Thus, the computation for estimating the transmission latency distribution is done only once, which can reduce calculation loads.

The receiver 1012 receives the object information from the object information obtainment unit 200, the environment information from the environment information obtainment unit 300, the mobile-object-1 information from the first mobile object 100, and the mobile-object-2 information from the second mobile object 101. As described above, the surrounding information is combined information of the object information and the environment information, and is designated as SURROUNDING INFORMATION in the drawings.

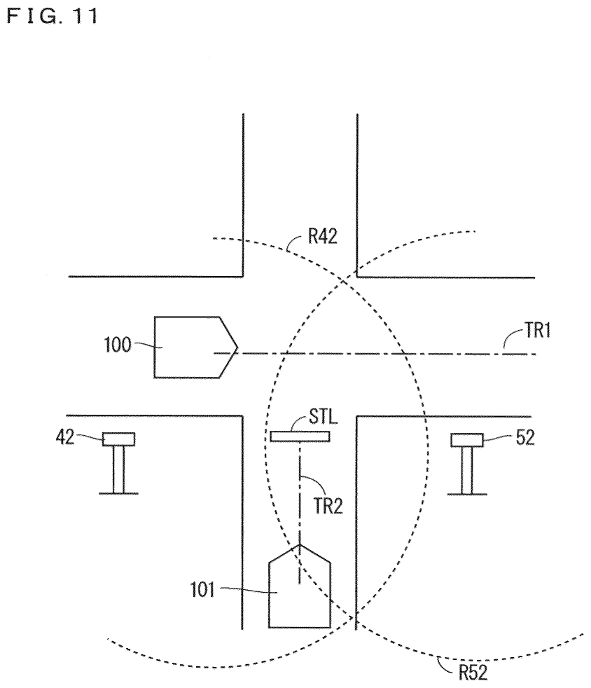

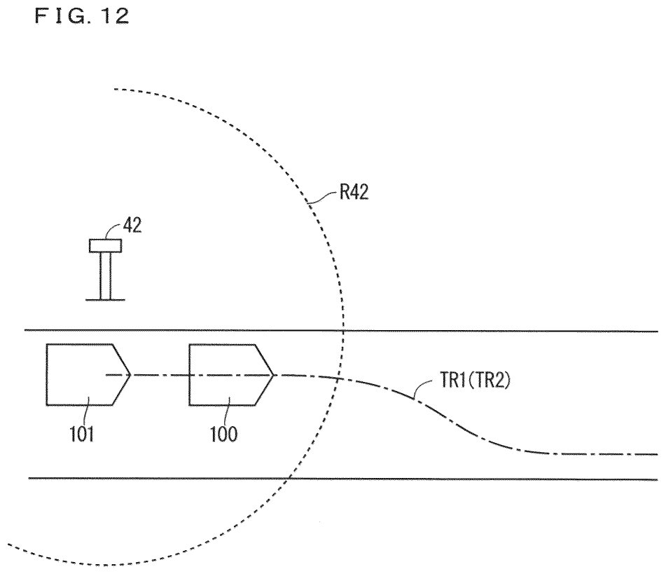

The trajectory generating unit 1002 generates a target trajectory of the first mobile object 100, that is, a mobile-object-1 target trajectory, and a target trajectory of the second mobile object 101, that is, a mobile-object-2 target trajectory, based on the map data from the map database 500 and the surrounding information from the receiver 1012. A method of generating respective target trajectories of two or more mobile objects by the trajectory generating unit 1002 will be described later in detail with reference to FIGS. 11 and 12.

The transmitter 1004 transmits the mobile-object-1 controlled amount from the first mobile object control unit 1031 and the mobile-object-2 controlled amount from the second mobile object control unit 1032, to the first mobile object 100 and the second mobile object 101, respectively, through the network NW.

### [Mobile Object Control Unit]

Next, the first mobile object control unit 1031 of the mobile object control unit 1003 will be described with reference to FIG. 3. FIG. 3 is a block diagram illustrating a configuration of the first mobile object control unit 1031.

As illustrated in FIG. 3, the first mobile object control unit 1031 includes a mobile object estimation unit 311, a controlled amount computation unit 312, a gain setting unit 313, and a control feasibility determination unit 314. When the remote control apparatus 1000 remotely controls two or more mobile objects, the second mobile object control unit 1032 in FIG. 2 has the same configuration as that of the first mobile object control unit 1031.

The mobile object estimation unit 311 can estimate a probability distribution of coefficients of state quantities of the first mobile object 100, that is, a coefficient distribution, based on the mobile-object-1 information from the receiver 1012. Here, the coefficients include a mass and a moment of inertia of the first mobile object 100, and a cornering stiffness when the first mobile object 100 is a vehicle. These coefficients may influence control stability and vary, similarly to the transmission latencies of the network NW. The coefficients are estimated based on an equation of state and state quantities on the first mobile object 100.

When values and the probability distribution of the coefficients of the state quantities of the first mobile object 100 are known, gains can be set using these pieces of information. Thus, the mobile object estimation unit 311 can be omitted.

The known probability distribution of the coefficients can be obtained from data obtained in advance and design values. As an example of obtaining the probability distribution from data obtained in advance, data on a cornering stiffness representing a relationship between a road surface and a tire is obtained once the first mobile object 100 travels along a road. Thus, the probability distribution can be obtained from such data. As an example of obtaining the probability distribution from design values, when the load of baggage and persons is defined as 100 kg to 200 kg as a specification of the first mobile object 100, a distribution of masses can be a probability distribution of 100 kg to 200 kg or a uniform distribution. For example, when baggage of 150 kg is frequency carried, a distribution of masses can be modeled with a peak of 150 kg as a normal distribution. When the probability distribution is obtained in advance, the control gain can be designed from the probability distribution obtained in such a manner.

The gain setting unit 313 sets a control gain based on the mobile-object-1 transmission latency distribution information from the transmission latency distribution estimation unit 1001.

The gain setting unit 313 sets a control gain based on the mobile-object-1 transmission latency distribution information and a coefficient distribution of state quantities of the first mobile object 100. Here, the equation of state on the first mobile object 100 can address stochastic variability except transmission latencies.

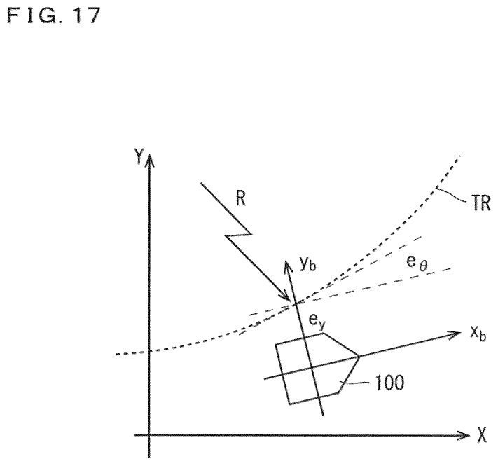

The controlled amount computation unit 312 computes a controlled amount for allowing the first mobile object 100 to follow a target trajectory, based on the mobile-object-1 information from the receiver 1012 and the control gain from the gain setting unit 313. A method for the gain setting unit 313 to set a control gain and a method for the controlled amount computation unit 312 to compute a controlled amount will be described later in detail with reference to FIG. 17 and the disclosure of Non-Patent Documents 1 and 2.

The control feasibility determination unit 314 determines whether to continue to control or stop controlling the first mobile object 100, based on the mobile-object-1 transmission latency distribution information from the transmission latency distribution estimation unit 1001. Alternatively, the control feasibility determination unit 314 determines whether to continue to control or stop controlling the first mobile object 100, based on the mobile-object-1 transmission latency distribution information and the coefficient distribution of state quantities of the first mobile object 100.

When a result of the determination is to “continue to control the first mobile object 100”, the control feasibility determination unit 314 outputs, to the transmitter 1004, the controlled amount for controlling the first mobile object 100, that is, the controlled amount from the controlled amount computation unit 312. When a result of the determination is to “stop controlling the first mobile object 100”, the control feasibility determination unit 314 sets a value for stopping the first mobile object 100 to the controlled amount, and outputs the controlled amount to the transmitter 1004. A method for determining whether to continue to control or stop controlling the first mobile object 100 will be described later in detail.

FIG. 4 is a block diagram illustrating another example configuration of the first mobile object control unit 1031. As illustrated in FIG. 3, the first mobile object control unit 1031 includes the mobile object estimation unit 311, the controlled amount computation unit 312, the gain setting unit 313, the control feasibility determination unit 314, and a state quantity estimation unit 315. When the remote control apparatus 1000 remotely controls two or more mobile objects, the second mobile object control unit 1032 in FIG. 2 has the same configuration as that of the first mobile object control unit 1031.

The first mobile object control unit 1031 differs from that in FIG. 3 in including the state quantity estimation unit 315. The state quantity estimation unit 315 estimates, based on the mobile-object-1 information from the 1012 receiver, the second state quantities different from the first state quantities obtained by sensors on, for example, a position, a speed, an acceleration, and an angular velocity from among the state quantities of the first mobile object 100. The second state quantities are state quantities that are not obtained from the sensors.

The state quantity estimation unit 315 estimates the second state quantities based on the equation of state on the first mobile object 100 and the mobile-object-1 information, by applying, for example, an observer, a Kalman filter, and a particle filter. Since the remote control apparatus 1000 controls the first mobile object 100 using the second state quantities that are not obtained from the sensors, the remote control apparatus 1000 can remotely control the first mobile object 100 with higher accuracy.

Although them is no illustration in FIG. 4, the second state quantities can be stochastically estimated using the transmission latency distribution information.

When estimating the coefficient distribution of state quantities of the first mobile object 100, the mobile object estimation unit 311 can use not only the mobile-object-1 information from the receiver 1012 but also the second state quantities from the state quantity estimation unit 315.

The controlled amount computation unit 312 computes a controlled amount, based on the mobile-object-1 information from the receiver 1012, the second state quantities from the state quantity estimation unit 315, and the control gain from the gain setting unit 313.

### [Mobile Object]

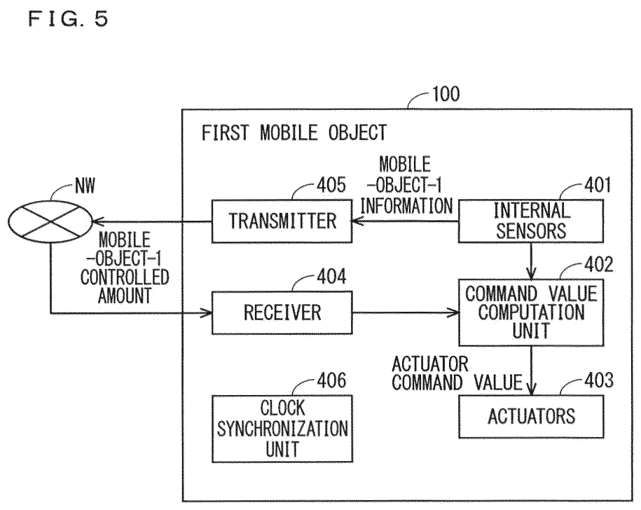

Next, a configuration of the first mobile object 100 will be described with reference to FIG. 5. FIG. 5 is a block diagram illustrating the configuration of the first mobile object 100. As illustrated in FIG. 5, the first mobile object 100 includes internal sensors 401, a command value computation unit 402, actuators 403, a receiver 404, a transmitter 405, and a clock synchronization unit 406. When the remote control apparatus 1000 remotely controls two or more mobile objects, the second mobile object 101 in FIG. 2 has the same configuration as that of the first mobile object 100.

The internal sensors 401 are sensors that detect internal information on the first mobile object 100 from, for example, an inertial measurement unit (IMU) sensor, a speed sensor, an acceleration sensor, a steering angle sensor, and a steering torque sensor, and output the internal information as the mobile-object-1 information to input the internal information into the network NW through the transmitter 405.

The command value computation unit 402 obtains the mobile-object-1 controlled amount computed by the mobile object control unit 1003 of the remote control apparatus 1000, through the receiver 404, and performs computation of transforming the mobile-object-1 controlled amount into an actuator command value that can be input into the actuators 403. The command value computation unit 402, for example, transforms a target steering angle into a control current value of an electric power steering (EPS). The actuators 403 include a motor that actually operates the first mobile object 100. Furthermore, the command value computation unit 402 computes the driving force and the braking force of a vehicle which are required to allow the acceleration of the vehicle to follow the target amount of acceleration or deceleration, and outputs the computation results to a vehicle driving device and a brake control device. An electric motor, the vehicle driving device, and the brake control device will be described later in detail with reference to FIG. 6.

The clock synchronization unit 406 has a function of synchronizing the timing of transmitting and receiving data in coordination with the clock synchronization unit 201 in the object information obtainment unit 200, the clock synchronization unit 310 in the environment information obtainment unit 300, and the clock synchronization unit 1011 in the remote control apparatus 1000.

The transmitter 405 transmits the mobile-object-1 information from the internal sensors 401 to the receiver 1012 in the remote control apparatus 1000 through the network NW. The receiver 404 receives the controlled amount from the transmitter 1004 of the remote control apparatus 1000.

Examples of the first mobile object 100 include a vehicle, an aircraft, a drone, an explorer, and farm machinery. In the presence of a plurality of mobile objects, the mobile objects can be combined. When the first mobile object 100 is not a vehicle and there is, for example, another mobile object or a pedestrian around the first mobile object 100, the object information obtainment unit 200 obtains, as the object information, a position and a speed of the other mobile object or the pedestrian. Furthermore, when the first mobile object 100 is not a vehicle, the environment information obtainment unit 300 accesses the map database 500, and obtains, for example, a movable region of the first mobile object 100 as the map data.

FIG. 6 illustrates an example structure of the first mobile object 100 when the first mobile object 100 is a vehicle. A steering wheel 1 installed for a driver, that is, an operator to operate the vehicle engages with a steering axle 2. The steering axle 2 engages with a pinion shaft 13 of a rack-and-pinion mechanism 4. A rack shaft 14 of the rack-and-pinion mechanism 4 is reciprocally movable according to rotation of the pinion shaft 13. Front knuckles 6 are connected to both ends of the rack shaft 14 through tie rods 5. The front knuckles 6 rotatably support front wheels 15 as steering tires, and are supported by a car frame so that the front wheels 15 are flexibly steerable.

Thus, a torque generated by the driver through operating the steering wheel 1 causes the steering axle 2 to rotate. The rack-and-pinion mechanism 4 moves the rack shaft 14 in a lateral direction according to rotation of the steering axle 2. Movement of the rack shaft 14 rotates each of the front knuckles 6 with respect to a kingpin axis that is not illustrated, and accordingly steers the front wheels 15 in the lateral direction. Thus, operating the steering wheel 1 by the driver when the vehicle moves forward and backward can vary an amount of lateral movement of the vehicle.

Unmanned mobile objects such as a fully autonomous vehicle and a drone do not need a constituent element for operations of a driver, such as a steering wheel.

For example, a vehicle speed sensor 20, an IMU sensor 21, a steering angle sensor 22, and a steering torque sensor 23 are installed in the first mobile object 100 as the internal sensors 401 each of which recognizes a traveling state of the first mobile object 100.

As described with reference to FIG. 5, the command value computation unit 402 performs computation of transforming the mobile-object-1 controlled amount into an actuator command value that can be input into each of the actuators 403, and inputs the actuator command value into each of an acceleration/deceleration control device 9 and a steering control device 12. Command value computation units sometimes include local feedback for controlling the actuators with high accuracy. In such a case, the command value computation units use sensor values obtained by the internal sensors. For example, when one of the actuators is an electric motor to be described later, the command value computation units compute an actuator command value with high accuracy, using a steering angle sensor and a steering torque sensor.

An electric motor 3 for implementing a lateral motion of the first mobile object 100, and actuators for controlling forward and backward motions of the first mobile object 100, such as a vehicle driving device 7 and a brake control device 10 are installed in the first mobile object 100.

The acceleration/deceleration control device 9 controls the vehicle driving device 7 and the brake control device 10. The steering control device 12 controls the electric motor 3.

The electric motor 3 typically includes a motor and a gear, and imparts a torque to the steering axle 2 so that the steering axle 2 can be flexibly rotated. In other words, the electric motor 3 can flexibly steer the front wheels 15, independently from operating the steering wheel by the driver.

The vehicle driving device 7 is an actuator for driving the first mobile object 100 in a forward and backward direction. The vehicle driving device 7 rotates the front wheels and rear wheels 16, by using, for example, driving force obtained from a driving source such as an engine or a motor, through a transmission and a shaft that are not illustrated. This enables the vehicle driving device 7 to flexibly control the driving force of the first mobile object 100.

The brake control device 10 is an actuator for braking the first mobile object 100, and controls a brake amount of a brake 11 installed at each of the front wheels 15 and the rear wheels 16 of the first mobile object 100. A typical brake generates braking force by pressing a pad against a disc rotor that rotates together with the front wheels 15 and the rear wheels 16, using hydraulic pressure.

The internal sensors and the other devices configure a network using, for example, a controller area network (CAN) or a local area network (LAN) in the first mobile object 100. Each of the devices in the first mobile object 100 in FIG. 5 can obtain information through this network. The internal sensors can mutually transmit and receive data through the network. Even when the first mobile object is not a vehicle, the first mobile object has the same configuration including actuators, internal sensors, and a command value computation unit.

### [Object Information Obtainment Units and Trajectory Generation]

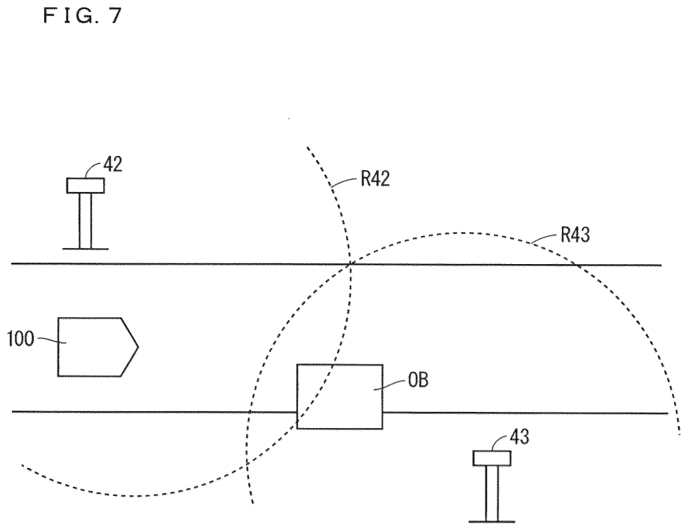

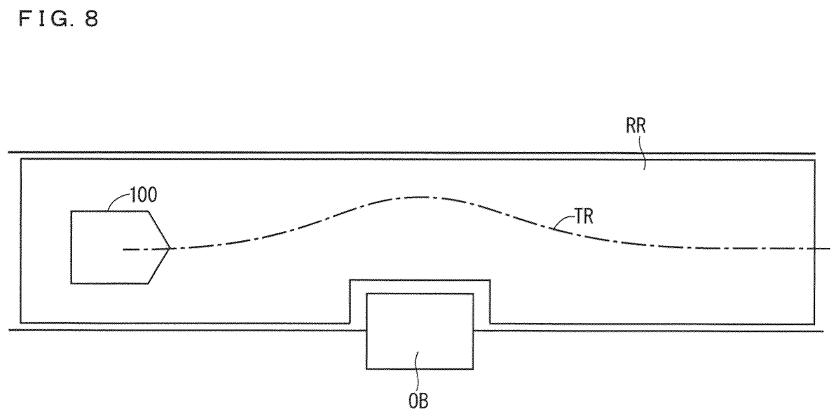

Next, example placement of the object information obtainment units 200 and an example target trajectory to be generated by the remote control apparatus 1000 will be described with reference to FIGS. 7 and 8. FIG. 7 illustrates a case where external sensors 42 and 43 are placed on a side of a road along which the first mobile object 100 travels, as the example placement of the object information obtainment units 200. A stop object OB exists ahead of the first mobile object 100. Detection ranges of the external sensor 42 and the external sensor 43 are a range R42 and a range R43, respectively.

FIG. 8 illustrates the target path TR for generating a target trajectory along which the first mobile object 100 avoids the stop object OB, when the stop object OB exists ahead of the first mobile object 100.

Examples of the external sensors 42 and 43 include a camera, a LiDAR, a radar, a sonar, and an infrared camera. The external sensors 42 and 43 detect positions and speeds of, for example, the first mobile object 100 and other objects. Although the external sensors 42 and 43 are placed on the side of the road in FIG. 7, the external sensors 42 and 43 can be mounted on the first mobile object 100.

The external sensor 42 in FIG. 7 detects a relative position and a relative speed of the first mobile object 100 with respect to the external sensor 42. Furthermore, the external sensors 42 and 43 detect relative positions and relative speeds of the stop object OB with respect to the external sensors 42 and 43. Each of the object information obtainment units 200 transforms information on the relative positions and the relative speeds of such a mobile object and the stop object OB with respect to the external sensors 42 and 43 into information on a relative position and a relative speed of the stop object OB when viewed from the first mobile object 100. Alternatively, the object information obtainment unit 200 calculates a relative position and a relative speed of the stop object OB with respect to the first mobile object 100 by transforming information on the relative positions and the relative speeds of the first mobile object 100 and the stop object OB with respect to the external sensors 42 and 43 into a coordinate system unified between the first mobile object 100 and the stop object OB, for example, a geographical coordinate system to be used in the GNSS.

The trajectory generating unit 1002 of the remote control apparatus 1000 generates the target path TR as illustrated in FIG. 8, based on these pieces of information. This target path TR is a path along which the first mobile object 100 avoids the stop object OB, and a path along which the first mobile object 100 travels within a traveling possible region RR. Although there is no illustration, the trajectory generating unit 1002 also generates a target speed of the first mobile object 100, and combines the target speed with the target path TR to be used as a target trajectory.

As one example, the trajectory generating unit 1002 generates a target speed so that the speed of the first mobile object 100 is reduced when the first mobile object 100 avoids the stop object OB. The trajectory generating unit 1002 generates a target trajectory (an avoidance trajectory) obtained by combining the target path with the target speed.

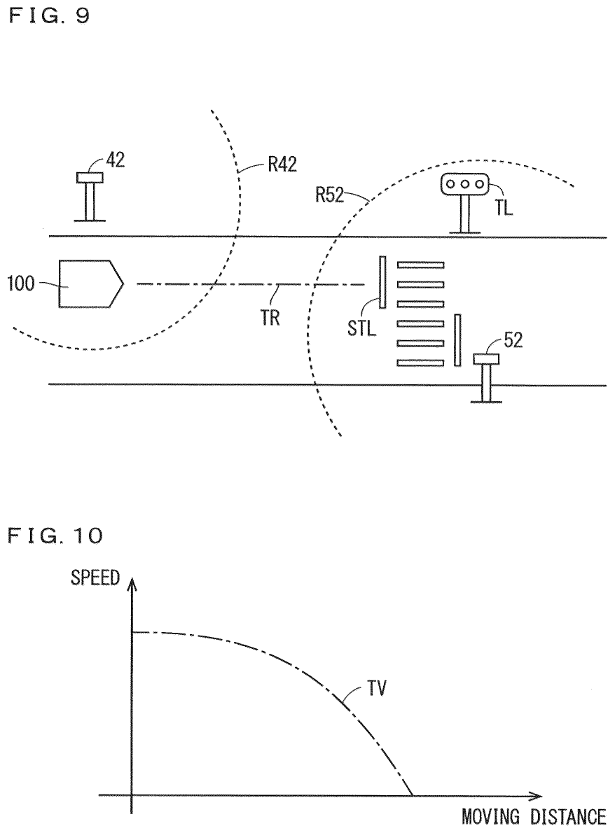

FIG. 9 illustrates example placement of the object information obtainment unit 200 and the environment information obtainment unit 300. FIG. 9 illustrates that the external sensor 42 is placed on a side of a road along which the first mobile object 100 travels as example placement of the object information obtainment unit 200 when a stop line STL and a traffic light TL are installed ahead of the first mobile object 100 and that an external sensor 52 is placed at a position at which the external sensor 52 can detect the stop line STL and an emission color of and the traffic light TL as example placement of the environment information obtainment unit 300. Detection ranges of the external sensor 42 and the external sensor 52 are a range R42 and a range R52, respectively.

The external sensor 42 in FIG. 9 detects a relative position and a relative speed of the first mobile object 100 with respect to the external sensor 42. The external sensor 52 detects relative positions of the stop line STL and the traffic light TL with respect to the external sensor 52.

The external sensor 42 in FIG. 9 detects a relative position and a relative speed of the first mobile object 100 with respect to the external sensor 42. The external sensor 52 detects the stop line STL and the emission color of the traffic light TL.

The trajectory generating unit 1002 of the remote control apparatus 1000 generates the target path TR indicated by alternate long and short dash lines, based on these pieces of information. This target path TR is a path for allowing the first mobile object 100 to proceed straight toward the stop line STL.

FIG. 10 illustrates an example target speed to be generated by the remote control apparatus 1000 when the stop line STL and the traffic light TL exist ahead as illustrated in FIG. 9. In FIG. 10, the horizontal axis represents a moving distance when the first mobile object 100 moves toward the stop line STL, and the vertical axis represents a speed of the first mobile object 100.

The trajectory generating unit 1002 sets a target speed TV indicated by alternate long and short dash lines in FIG. 9. This target speed TV is a speed obtained by gradually reducing the speed of the first mobile object 100 to become zero at the stop line STL in FIG. 8. The trajectory generating unit 1002 generates a target trajectory (a stop trajectory) obtained by combining the target path with the target speed.

As illustrated in FIGS. 7 to 9, the target trajectories include an avoidance trajectory of the stop object OB, and the stop trajectory until the first mobile object 100 stops. The target trajectories are not limited to these two trajectories, but include various trajectories corresponding to roads along which the first mobile object 100 travels. Although it is conceivable that the first mobile object 100 itself generates a target trajectory, it is preferred that the trajectory generating unit 1002 generates a target trajectory to achieve greater versatility of the first mobile object 100. This produces an advantage of simplifying the configuration of the first mobile object 100.

Although FIGS. 7 to 9 illustrate the one mobile object to be remotely controlled, even in the presence of two or more mobile objects to be remotely controlled, target trajectories are generated in the same method. This example will be described with reference to FIGS. 1 and 12.

FIG. 11 illustrates an example method for the trajectory generating unit 1002 to generate target trajectories of two or more mobile objects. FIG. 11 illustrates a method of generating target trajectories when the first mobile object 100 and the second mobile object 101 travel through an intersection. FIG. 11 illustrates that the external sensor 42 as the object information obtainment unit 200 and the external sensor 52 as the environment information obtainment unit 300 are placed around the first mobile object 100 and the second mobile object 101 and on a side of a road along which the first mobile object 100 travels. Furthermore, the stop line STL exists ahead of a road along which the second mobile object 101 travels.

The detection ranges of the external sensor 42 and the external sensor 52 are the range R42 and the range R52, respectively. The external sensors 42 and 52 are disposed at a distance in which the detection ranges R42 and R52 indicated by broken lines partly overlap. The external sensor 42 covers the first mobile object 100 and the second mobile object 101 that are approaching the intersection.

The external sensor 42 detects a relative position and a relative speed of each of the first mobile object 100 and the second mobile object 101 with respect to the external sensor 42. The external sensor 52 detects a relative position of the stop line STL with respect to the external sensor 52. The trajectory generating unit 1002 generates a target path TR1 of the first mobile object 100, based on these pieces of information. Although there is no illustration, the trajectory generating unit 1002 also generates a target speed of the first mobile object 100. The trajectory generating unit 1002 generates a target speed such that the first mobile object 100 travels along the target path TR1 at a constant speed.

The trajectory generating unit 1002 also generates a target path TR2 of the second mobile object 101. Although there is no illustration, the trajectory generating unit 1002 also generates a target speed of the second mobile object 101. The target speed of the second mobile object 101 is a speed gradually reduced as the second mobile object 101 is approaching the stop line STL to become zero at the stop line STL.

The trajectory generating unit 1002 generates a target trajectory of the first mobile object 100 which is obtained by combining the target path TR1 with the target speed. Similarly, the trajectory generating unit 1002 generates a target trajectory of the second mobile object 101 which is obtained by combining the target path TR2 with the target speed.

Furthermore, in the situation of FIG. 11, the trajectory generating unit 1002 generates a target trajectory with considerations given to the priority of traveling of the first mobile object 100. In other words, the trajectory generating unit 1002 generates target trajectories for the first mobile object 100 and the second mobile object 101 so that the stop line STL detected by the sensor 52 gives a high priority to traveling of the first mobile object 100.

FIG. 12 illustrates an example method for the trajectory generating unit 1002 to generate target trajectories of two or more mobile objects. FIG. 12 illustrates a method of generating target trajectories when the first mobile object 100 and the second mobile object 101 are platooning. FIG. 12 illustrates that the external sensor 42 as the object information obtainment unit 200 is placed on a side of a road along which the first mobile object 100 and the second mobile object 101 travel. The detection range of the external sensor 42 is the range R42. The external sensor 42 covers the first mobile object 100 and the second mobile object 101.

The external sensor 42 detects a relative position and a relative speed of each of the first mobile object 100 and the second mobile object 101 with respect to the external sensor 42. The trajectory generating unit 1002 generates a target trajectory of the first mobile object 100, based on these pieces of information. In other words, the trajectory generating unit 1002 generates the target path TR1 and a target speed (not illustrated) of the first mobile object 100. As one example, the trajectory generating unit 1002 generates a target speed such that the first mobile object 100 travels along the target path TR1 at a constant speed.

The trajectory generating unit 1002 also generates a target trajectory of the second mobile object 101. In other words, the trajectory generating unit 1002 generates the target path TR2 and a target speed (not illustrated) of the second mobile object 101. The trajectory generating unit 1002 generates target trajectories of the first mobile object 100 and the second mobile object 101 such that the position of the second mobile object 101 is separated from that of the first mobile object 100 by a predetermined rearward distance. In other words, the trajectory generating unit 1002 generates a target trajectory along which the second mobile object 101 is platooning with the first mobile object 100 that is a leader among mobile objects.

Here, the target speed of the second mobile object 101 is identical to that of the first mobile object 100, and the target path TR1 of the first mobile object 100 is identical to the target path TR2 of the second mobile object 101.

The trajectory generating unit 1002 can generate target trajectories such that the target path TR1 is different from the target path TR2, according to a situation including obstacles around the first mobile object 100 and the second mobile object 101.

As described with reference to FIGS. 11 and 12, the trajectory generating unit 1002 generates target trajectories for a plurality of mobile objects. Although it is conceivable that each of the mobile objects generates a target trajectory, collectively generating target trajectories by the trajectory generating unit 1002 can increase the efficiency and reduce calculation loads.

### [Transmission Latency Distribution Estimation Unit]

FIG. 13 is a block diagram illustrating an example configuration of the transmission latency distribution estimation unit 1001. In this example, the transmission latency distribution estimation unit 1001 includes a transmission latency preprocessing unit and a transmission latency model unit.

The transmission latency preprocessing unit 111 has a function of transforming the transmission latency information from the transmission latency measurement unit 1013 into transmission latency features to be referred to by the transmission latency model unit 112. Examples of the transmission latency features can include an average value, variance, and a higher moment of a transmission latency distribution within a predefined time segment. Alternatively, the maximum value and the minimum value of transmission latencies within a time segment can be used as transmission latency features.

The transmission latency model unit 112 has a function of estimating at least a probability distribution of the current transmission latencies, using the transmission latency features calculated by the transmission latency preprocessing unit 111 with reference to a transmission latency model built in advance, and outputting the probability distribution as the transmission latency distribution information. Examples of the transmission latency distribution information can include information except the probability distribution, such as a current or past mode in a hidden Markov model to be described later. Although various models can be used for the transmission latency model unit 112, the hidden Markov model (hereinafter abbreviated as the “HMM”) will be described as an example transmission latency model in this disclosure.

The HMM is a built probability model in which each mode (a state) that outputs a sequence that follows a discrete or continuous probability distribution transitions according to a transition probability defined between the modes. The probability distribution corresponding to each of the modes in the HMM will be referred to as an output distribution.

The output of the HMM and transition between the modes will be described. For example, when the HMM is in a mode A at a certain time, a sequence that follows a probability distribution of the mode A is output. The mode may transition to another mode according to a certain transition probability, and a probability distribution of the output may be changed. For example, when the mode A transitions to a mode B, a sequence corresponding to a probability distribution of the mode B is output in a time segment in the mode B. Since it is not possible to directly observe in which mode the HMM currently is but only the output sequence is observed, the model is named “hidden”.

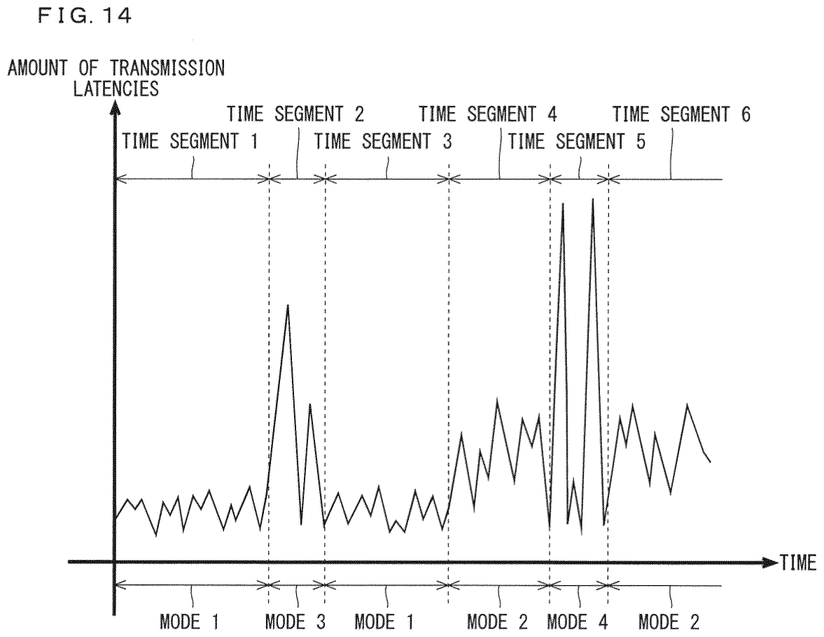

Next, the cause why transmission latencies can be modeled by the HMM will be described with reference to FIG. 14. FIG. 14 illustrates an example time series of transmission latencies. FIG. 14 illustrates sequences of times in the horizontal axis and the amounts of transmission latencies in the vertical axis, which can be easily obtained using the output of the transmission latency measurement unit 1013.

When, for example, a dedicated line is not used, the transmission latencies typically do not take constant values but always take various values. FIG. 14 illustrates such a state, and clarifies that how the transmission latencies vary is changed for each time segment. In FIG. 14, how the transmission latencies vary is equivalent between time segments 1 and 3 or between time segments 4 and 6, and time segments 2 and 5 are clearly segments in which large transmission latencies easily occur.

Assuming that the sequence of transmission latencies is output according to the HMM, modes of the time segments having the same tendency in how the transmission latencies vary can be equated. In other words, the time segments 1 and 3, and the time segments 2 and 4 can be regarded having identical modes of a mode 1 and a mode 2, respectively. Similarly, the time segment 2 and the time segment 5 can be regarded as a mode 3 and a mode 4, respectively.

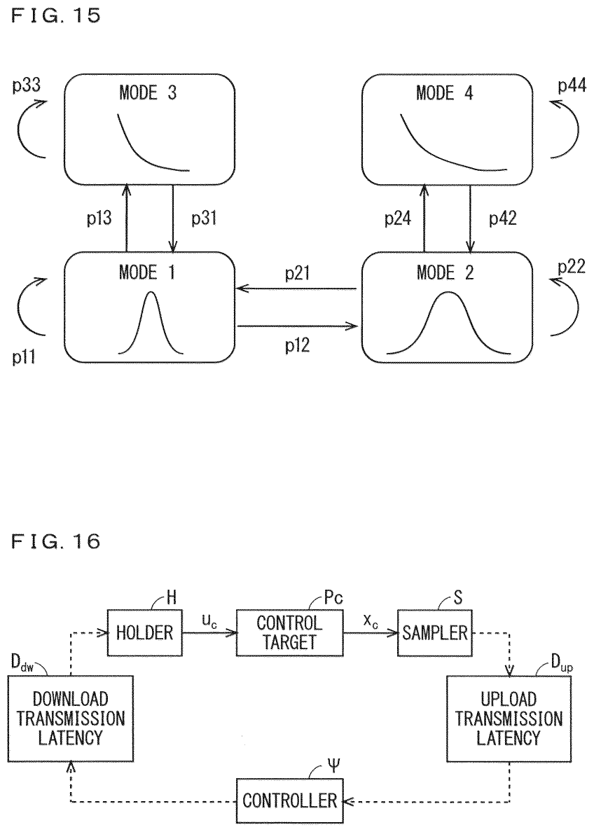

When these transmission latencies are represented by the HMM, they can be modeled as illustrated in FIG. 15. FIG. 15 illustrates the HMM having four modes, and respective latency modes can be represented as below.
A mode 1: a normal distribution with a relatively low average and relatively small variance
A mode 2: a normal distribution with a high average and large variance
A mode 3: an exponential distribution with a low average
A mode 4: an exponential distribution with a high average

Note that these distributions are merely imaginary, and actual communication latencies do not take a negative value, unlike a normal distribution.

In FIG. 15, pᵢⱼ (i=1, 2, 3, 4, j=1, 2, 3, 4) is a transition probability from a mode i at a transition source to a mode j at a transition destination. For example, when a transition source mode is 1, p11, p12, and p13 represent a transition probability from the mode 1 to the mode 1, a transition probability from the mode 1 to the mode 2, and a transition probability from the mode 1 to the mode 3, respectively. The same holds true for the modes 2, 3, and 4.

In this manner, the transmission latencies can be modeled by the HMM as an example transmission latency model.

The view of the Inventors on the cause why the transmission latencies have such a model is as follows. Path control is performed in a typical network so that a packet that is a unit of data to be transmitted and received is efficiently delivered to an accurate destination with high reliability. This path control may change a transmission path of the packet. Transition of a mode can be interpreted as representation of a condition of switching the transmission path. Although such path control is less frequently performed in a small-scaled network, the frequency of switching between transmission paths is high and changes in how the transmission latencies vary are significant in a large-scaled network. Switching between transmission paths in such a manner can be interpreted as switching between the modes.

Actually, other factors, for example, surrounding circumstances of a mobile object may be the cause. Embodiment 2 will describe a method of addressing the cause.

Although the modes in FIG. 15 are used for describing the HMM in the present disclosure, increase or decrease in the number of modes and a probability distribution of each of the modes can be freely set.

[Difference with i.i.d.]

Patent Document 1 hypothesizes that transmission latencies follow i.i.d. with time. In contrast, a probability distribution of transmission latencies of which variations are changed as illustrated in FIG. 14 is clearly changed. In other words, the probability distribution of transmission latencies is time-changed, and is a probability distribution in which values are time-dependent. Thus, it can be said that the i.i.d. hypothesis does not hold.

Since a control gain is set under a hypothesis that transmission latencies follow i.i.d. with time in Patent Document 1, there is room for improvement in improving the remote control performance.

As already described, the method of Patent Document 1 is effective when a network is small-scaled, or when it is assumed that obstacles around a mobile object are few and transmission latencies follow i.i.d. with time.

### [Method of Creating and Referencing HMM]

A method of creating the HMM will be hereinafter described. First, the transmission latency measurement unit 1013 defines, in advance, sequence data on transmission latencies obtained for each certain duration, e.g., 1 hour, obtained periodically, e.g., at intervals of 0.01 second, or obtained non-periodically as one set, and obtains a plurality of the sets. The plurality of data sets obtained is defined as “prior information”.

For example, a time interval, for example, approximately one second is defined for the obtained data sets. Amounts in which a mode of transmission latencies can be estimated at the time intervals, such as an average, variance, and, the maximum value, and the minimum value are defined as transmission latency features. The transmission latency features can be defined as the “prior information”. The modes are categorized for each of the transmission latency features by a method such as clustering. This operation is performed on the plurality of data sets to obtain, for example, transition probabilities between the modes, and an output distribution of the modes. This can complete the final HMM.

The transmission latency information obtained online from the transmission latency measurement unit 1013 when the first mobile object 100 is actually controlled is defined as “posterior information” to be distinguished from the prior information. The posterior information means transmission latency information to be obtained when the remote control apparatus 1000 remotely controls the first mobile object 100. Creating the HMM based on the prior information can shorten the time required to create the HMM. Creating the HMM based on the posterior information can create the HMM that greatly matches the reality. A method of creating the HMM based on the posterior information will be described in Embodiment 3.

Creating such HMM can obtain online the transmission latency distribution information including in which mode the transmission latency currently is and an output distribution of the mode, using the transmission latency features from the transmission latency measurement unit 1013.

The HMM has been widely used in the speech recognition field, and the method of creating the HMM such as the Baum-Welch algorithm has been widely developed. Thus, the HMM can be created using these technologies.

When the transmission latency model unit 112 does not need transmission latency features, that is, when the transmission latency model unit 112 uses data on transmission latencies as reference values of the HMM as they are, the transmission latency preprocessing unit 111 can be omitted.

### [Stability of Stochastic System]

To facilitate the understanding of the method of creating the HMM according to the present disclosure, definition of the stability of a control target (will be hereinafter referred to as a “stochastic system”) with variations such as transmission latencies, and a value expression for evaluating the stability will be described with reference to Non-Patent Document 1.

First, k is an integer representing time. ξₖ is a z-dimensional real vector, and represents a random variable following a certain probability distribution at the time k. A stochastic process (ξₖ) given as a sequence of ξₖ on k is written as ξ. Furthermore, ξ^{k0-} denotes a stochastic process ξₖ prior to the time k₀, and ξ^{k0+} denotes a stochastic process ξₖ after the time k₀. Since the value of ξ^{k0-} after the time k₀ is obtained, if the obtained ξ^{k0-} is written as ξₕ^{k0-}, Equation (1) below represents the initial condition of the stochastic process after the time k₀.

$$\begin{matrix}[ Math 1 ] & \\ {ξ}^{( k 0 - 1 ) -} = {ξ}_{h}^{( k 0 - 1 ) -} & ( 1 )\end{matrix}$$

A conditional expected value under a condition in which an event Ap has occurred is written as E[(⋅)|Ap]. A conditional expected value Eₖ₀[⋅] represented by Equation (2) below is introduced to define the stability of a stochastic system.

$$\begin{matrix}[ Math 2 ] & \\ {E}_{k 0} [ \cdot ] := E [ ( \cdot ) \vert {ξ}^{( k 0 - 1 ) -} = {ξ}_{h}^{( k 0 - 1 ) -} ] & ( 2 )\end{matrix}$$

In other words, Equation (2) means the expected value under a condition that a value of the stochastic process ξ until the time k₀ has been ξₕ^{(k0-1)-}.

Next, a discrete time state equation of the stochastic system is represented by Equation (3) below.

$$\begin{matrix}[ Math 3 ] & \\ {x}_{k + 1} = A ( {ξ}_{k} ) {x}_{k} & ( 3 )\end{matrix}$$

In Equation (3), xₖ is a n-dimensional vector representing a state of a mobile object at the time k, and Aₖ(ξₖ) is a n×n random matrix defined by ξₖ. It is hypothesized that M_{A}(k) that takes a positive real number satisfying Equation (4) below exists at any time k to define the stability of this random matrix.

$$\begin{matrix}[ Math 4 ] & \\ {E}_{k} [ {{A}_{ij} ( {ξ}_{k} )}^{2} ] \leq {M}_{A} ( k ) & ( 4 )\end{matrix}$$

Here, i, j=1 . . . n, and Aᵢⱼ(ξₖ) is an (i,j) element of A(ξₖ). Equation (4) means that a conditional expected value exists under a condition in which ξₕ^{k0-} in each element of A(ξₖ) has occurred.

According to Non-Patent Document 1, the stochastic system of Equation (3) is second-moment exponentially stable, that is, stable in the presence of a and λ satisfying Equation (5) below under a hypothesis of Equation (4), where a is a real number taking a positive value, and λ is a real number satisfying 0<λ<1.

$$\begin{matrix}[ Math 5 ] & \\ {E}_{k 0} [ {‖ {x}_{k} ‖}^{2} ] \leq a {‖ {x}_{k 0} ‖}^{2} {λ}^{2 ( k - {k}_{0} )} & ( 5 )\end{matrix}$$

Here, ∥xₖ∥ denotes a Euclidean norm, and k0 denotes a time satisfying k>k0.

Non-Paten Document 1 proves that the stochastic system of Equation (3) being second-moment exponentially stable under a hypothesis of Equation (4) is equivalent to satisfying the following conditions. In other words, the stochastic system is second-moment exponentially stable in the presence of ε_{d}, εᵤ, λ, and P which satisfy Equations (6) and (7) below, assuming ε_{d} and εᵤ are real numbers taking positive values, λ is a real number satisfying 0<λ<1, and P(ξ) is a map for mapping the stochastic process ξ to an n×n dimensional symmetric matrix.

$$\begin{matrix}[ Math 6 ] & \\ {ϵ}_{d} {I}_{n \times n} \leq {E}_{k 0} [ P ( {S}_{k 0} {ξ}^{k 0 +} ) ] \leq {ϵ}_{u} {I}_{n \times n} & ( 6 )\end{matrix}$$

$$\begin{matrix}[ Math 7 ] & \\ {E}_{k 0} ⌈ {λ}^{2} P ( {S}_{k 0} {ξ}^{k 0 +} ) - {A ( {ξ}_{k 0} )}^{𝒯} {E}_{k 0} ⌈ P ( {S}_{k 0 + 1} {ξ}^{( k 0 + 1 ) +} ) \vert {F}_{k 0} ⌉ A ( {ξ}_{k 0} ) ⌉ \geq 0 & ( 7 )\end{matrix}$$

Sₖ₀ is a time shift operator, and is defined so that ζ=Sₖ₀ξ^{k0+} obtained by operating ξ^{k0+} on Sₖ₀ becomes ζ₀=ξₖ₀, ζ₁=ξₖ₀₊₁, . . . . Furthermore, I_{n×n} is a n×n unit matrix, and Fₖ is a σ-additive family (may be referred to as a “completely additive family”) generated by ξₖ₀, . . . , ξₖ. It is clear that Equations (6) and (7) become conditional expressions that are infinitely simultaneous with time, because, for example, P includes Sₖ₀ξ^{k0+}.

Equations (6) and (7) generally hold for a stochastic system satisfying the hypothesis of Equation (4). Thus, it can be said that the stochastic system is second-moment exponentially stable if Equation (4) is satisfied for stochastic processes of various classes including probability distributions without any upper limit value and non-i.i.d. and time-changed stochastic processes and if conditions of Equations (6) and (7) hold. For example, the classes on the time-changed stochastic processes include the HMM and a martingale. When it can be assumed that transmission latencies follow the stochastic processes of these classes, the control gain can be designed based on the stable conditions. The following will describe the stable conditions of the HMM and a method of designing the control gain, with reference to Non-Patent Document 2.

### [Stable Conditions of HMM and Designing Control Gain]

Assuming that the HMM consists of N modes, each of the modes will be referred to as a mode 1, a mode 2, . . . , and a mode N. Output distributions of the respective modes are D₁, D₂, . . . , and D_{N}, and σₖ denotes the mode at each time k (i.e., σₖ takes 1, 2, . . . , and N). Furthermore, ηₖ denotes a probability distribution output by the HMM at the time k, and follows a probability distribution of any one of D₁, D₂, . . . , and D_{N} at each time. pᵢⱼ denotes a time-invariant transition probability from a mode i to a mode j. The transition between the modes of the HMM is represented by Equation (8) below if the transition follows a regulation and aperiodic Markov chain.

$$\begin{matrix}[ Math 8 ] & \\ P ( {σ}_{k + 1} = j \vert {σ}_{k} = i ) = {p}_{ij} , {p}_{ij} \geq 0 , {\sum }_{j = 1}^{N} {p}_{ij} = 1 & ( 8 )\end{matrix}$$

ηₖ is independent at each of times with the same mode. Here, it is assumed that the stochastic process ξ is given by a sequence of real vectors ξₖ on the time k which are represented by Equation (9) below.

$$\begin{matrix}[ Math 9 ] & \\ {ξ}_{k} = [ \begin{matrix}{η}_{k} \\ {σ}_{k}\end{matrix} ] & ( 9 )\end{matrix}$$

According to Non-Patent Document 2, when the stochastic system satisfying the hypothesis of Equation (4) by using Equation (9) as the stochastic process ξ is second-moment exponentially stable, the next condition is satisfied. In other words, the stochastic system is second-moment exponentially stable in the presence of λ and Pᵢ which satisfy Equation (10) below, where λ is a real number satisfying 0<λ<1 and Pᵢ (i=1, . . . , N) denotes a positive definite matrix (all eigenvalues are equivalent to positive real numbers).

$$\begin{matrix}[ Math 10 ] & \\ {λ}^{2} {P}_{i} - {\sum }_{j = 1}^{N} {p}_{ij} {G}_{j}^{′ T} ( {P}_{j} ⊗ {I}_{{\tilde{n}}_{i}} ) {G}_{j}^{′} \geq 0 & ( 10 )\end{matrix}$$

Here, a superscript “T” denotes transposition of a matrix. A symbol with a cross in a circle denotes a Kronecker product.

Gⱼ′ denotes a matrix obtained by the following method. First, a row (A) is a row vector in which elements of a row “A” are aligned in order from the first row. ξ^{(j)} denotes a random variable represented by Equation (11) below, using a random variable η^{(j)} following a distribution Dj.

$$\begin{matrix}[ Math 11 ] & \\ {ξ}^{( j )} = [ \begin{matrix}{η}^{( j )} \\ j\end{matrix} ] & ( 11 )\end{matrix}$$

Gⱼ′ first decomposes a n²×n² matrix E [row(A(ξ^{(j)}))^{T} row (A(τ^{(j)}))] as indicated by Equation (12) below to obtain a nⱼ×n matrix Gⱼ.

$$\begin{matrix}[ Math 12 ] & \\ {G}_{j}^{T} {G}_{j} = E [ row {( A ( {ξ}^{( j )} ) )}^{T} row ( A ( {ξ}^{( j )} ) ) ] & ( 12 )\end{matrix}$$

Gⱼ is represented by Equation (13).

$$\begin{matrix}[ Math 13 ] & \\ {G}_{j} := [ {G}_{1 j} , … , {G}_{nj} ] & ( 13 )\end{matrix}$$

With this, Equation (14) below defines Gⱼ′ as a n′nⱼ×n matrix, using each of G₁ⱼ, . . . , Gₙⱼ of a nⱼ×n² matrix.

$$\begin{matrix}[ Math 14 ] & \\ {G}_{j}^{′} := {[ {G}_{1 j}^{T} , … , {G}_{nj}^{T} ]}^{T} & ( 14 )\end{matrix}$$

Since transmission latencies can be represented by the HMM, the stability of a control target can be evaluated using a value expression of Equation (10).

Next, a method of designing the control gain using Equation (10) will be described. First, a discrete time state equation represented by Equation (15) below to which a term of a control input has been added is considered for the stochastic system represented by Equation (3).

$$\begin{matrix}[ Math 15 ] & \\ {x}_{k + 1} = A ( {ξ}_{k} ) {x}_{k} + B ( {ξ}_{k} ) {u}_{k} & ( 15 )\end{matrix}$$

Here, uₖ is a m-dimensional vector representing a control input. A hypothesis on B(ξk) that M_{B}(k) taking a positive real number satisfying Equation (16) below exists at any time k is made, similarly to the hypothesis on Equation (4).

$$\begin{matrix}[ Math 16 ] & \\ {E}_{k} [ {{B}_{ij} ( {ξ}_{k} )}^{2} ] \leq {M}_{B} ( k ) & ( 16 )\end{matrix}$$

Here, i=1 . . . n, j=1 . . . m, and Bᵢⱼ(ξk) is an (i, j) element of B(ξk).

Hereinafter, it is assumed that a stochastic system of Equation (15) satisfies the hypotheses of Equations (4) and (16), and this stochastic system will be referred to as a control target.

The following three methods on a design policy of the control gain will be described as examples of the present disclosure.
Method 1: a method using a current mode
Method 2: a method not using any mode
Method 3: a method using a past mode

### [Method 1: Method Using Current Mode]

It can be assumed that each of output distributions at times in the same mode is i.i.d. with the time k. Thus, a method of switching the control gain can be used according to the mode at each time, using mode information of transmission latencies obtained by the transmission latency distribution estimation unit 1001 (FIG. 1).

Assuming that ηₖ⁽ⁱ⁾ denotes a random variable representing a transmission latency at a time in the mode i, and F⁽ⁱ⁾ denotes the control gain, a discrete time state equation of a control target and the control input uₖ are represented by Equation (17) and Equation (18), respectively, below at the time in the mode i.

$$\begin{matrix}[ Math 17 ] & \\ {x}_{k + 1} = A ( {η}_{k}^{( i )} ) {x}_{k} + B ( {η}_{k}^{( i )} ) {u}_{k} & ( 17 )\end{matrix}$$

$$\begin{matrix}[ Math 18 ] & \\ {u}_{k} = {F}^{( i )} {x}_{k} & ( 18 )\end{matrix}$$

Here, F⁽ⁱ⁾ denotes a m×n matrix. Since i.i.d. is assumed at the time in the mode i, the control gain F⁽ⁱ⁾ in each of the modes can be obtained using the method of Patent Document 1. In actual control, the control gain is switched for each of the modes that change moment by moment.

### [Method 2: Method not Using any Mode]

According to Non-Patent Document 2, a control gain F that does not depend on the mode represented by Equation (19) below can be designed.

$$\begin{matrix}[ Math 19 ] & \\ {u}_{k} = {Fx}_{k} & ( 19 )\end{matrix}$$

Here, F denotes a m×n matrix. Equation (15) is represented by Equation (20) below under this control gain.

$$\begin{matrix}[ Math 20 ] & \\ {x}_{k + 1} = ( A ( {ξ}_{k} ) + B ( {ξ}_{k} ) F ) {x}_{k} & ( 20 )\end{matrix}$$

Hereinafter, a coefficient matrix of a closed-loop system is represented by Equation (21) below.

$$\begin{matrix}[ Math 21 ] & \\ {A}_{ci} ( {ξ}_{k} ) = A ( {ξ}_{k} ) + B ( {ξ}_{k} ) F & ( 21 )\end{matrix}$$

In Equation (20), if the control gain F with which Equation (10) becomes second-moment exponentially stable can be obtained, using a design variable F, the control target can be stabilized. A method of obtaining F is derived from Non-Patent Document 2. In other words, the control gain F that stabilizes a control target exists in the presence of λ, X, and Y which satisfy the conditions represented by Equation (22) below, where λ is a real number satisfying 0<λ<1, X denotes a n×n positive definite matrix, and Y denotes a m×n matrix.

$$\begin{matrix}[ Math 22 ] & \\ [ \begin{matrix}{λ}^{2} X & {{p}_{i 1} [ {H}_{A 1}^{′} X + {H}_{B 1}^{′} Y ]}^{T} & {{p}_{i 2} [ {H}_{A 2}^{′} X + {H}_{B 2}^{′} Y ]}^{T} & ⋯ & {{p}_{iN} [ {H}_{AN}^{′} X + {H}_{BN}^{′} Y ]}^{T} \\ {{p}_{i 1} [ {H}_{A 1}^{′} X + {H}_{B 1}^{′} Y ]}^{T} & {p}_{i 1} X ⊗ {I}_{n 1} & {0}_{n 1 \cdot n \times n 2 \cdot n} & ⋯ & {0}_{n 1 \cdot n \times nN \cdot n} \\ {{p}_{i 2} [ {H}_{A 2}^{′} X + {H}_{B 2}^{′} Y ]}^{T} & {0}_{n 2 \cdot n \times n 1 \cdot n} & {p}_{i 2} X ⊗ {I}_{n 2} & ⋯ & {0}_{n 2 \cdot n \times nN \cdot n} \\ ⋮ & ⋮ & ⋮ & ⋱ & ⋮ \\ {{p}_{iN} [ {H}_{AN}^{′} X + {H}_{BN}^{′} Y ]}^{T} & {0}_{nN \cdot n \times n 1 \cdot n} & {0}_{nN \cdot n \times n 2 \cdot n} & ⋯ & {p}_{iN} X ⊗ {I}_{nN}\end{matrix} ] \geq 0 ( i = 1 , … , N ) & ( 22 )\end{matrix}$$

Particularly, F=YX⁻¹ is one of the control gains. Here, when ξ(j) is written as Equation (11), to define a matrix H′_{Aj} and a matrix H′_{Bj}, first, a matrix Hⱼ is defined as Equation (23) below.

$$\begin{matrix}[ Math 23 ] & \\ {H}_{j}^{T} {H}_{j} = E [ {[ row ( A ( {ξ}^{( j )} ) ) row ( B ( {ξ}^{( j )} ) ) ]}^{T} [ row ( A ( {ξ}^{( j )} ) ) row ( B ( {ξ}^{( j )} ) ) ] ] & ( 23 )\end{matrix}$$

Then, the matrix Hⱼ satisfying Equation (23) is a nj×n (n+m) matrix represented by Equation (24) below.

$$\begin{matrix}[ Math 24 ] & \\ {H}_{j} = [ {H}_{Aj 1} , … , {H}_{Ajn} , {H}_{Bj 1} , … , {H}_{Bjn} ] & ( 24 )\end{matrix}$$

The matrix H′_{Aj} and the matrix H′_{Bj} are a nj′n×n matrix and a nj′n×m matrix defined by Equation (25) and Equation (26), respectively, below. In the following, j takes j=1, . . . , and N.

$$\begin{matrix}[ Math 25 ] & \\ {H}_{Aj} = {[ {H}_{Aj 1}^{T} , … , {H}_{Ajn}^{T} ]}^{T} & ( 25 )\end{matrix}$$

$$\begin{matrix}[ Math 26 ] & \\ {H}_{Bj} = {[ {H}_{Bj 1}^{T} , … , {H}_{Bjn}^{T} ]}^{T} & ( 26 )\end{matrix}$$

Equation (22) is a linear matrix inequality (hereinafter abbreviated as “LMI)” in which the modes 1 to N are simultaneous. Since the values of X and Y can be obtained with fixed λ, using a tool for solving linear matrix inequalities, such as MATLAB (trademark), the control gain F can be calculated using the obtained X and Y. The control gain F with a high convergence rate can be designed by minimizing λ through, for example, a bisection method.

The control system can be stabilized under the HMM by controlling the control target using the control gain F obtained in such a manner.

### [Method 3: Method Using Past Mode]

Non-Patent Document 2 further describes a method using a past mode. In other words, the control input uₖ is represented by Equation (27) below, using the control gain F_{σk-1} that depends on the past mode.

$$\begin{matrix}[ Math 27 ] & \\ {u}_{k} = {F}_{σ k - 1} {x}_{k} & ( 27 )\end{matrix}$$

Here, F_{σk-1} denotes a n×n matrix. Equation (27) means that the control gain Fⱼ designed in the mode j is used at the current time, for example, when j denotes a past mode (i.e., σₖ₋₁=j), and i denotes the current mode (i.e., σₖ=i) on Fᵢ designed in each mode.

If a design variable Fᵢ that can satisfy the value expression of Equation (10) can be obtained, a control target can be stabilized. A method of obtaining Fᵢ is derived from Non-Patent Document 2. In other words, the design variable Fᵢ that stabilizes a control target exists in the presence of λ, Xᵢ, and Yᵢ which satisfy the conditions represented by Equation (28) below, where λ is a real number satisfying 0<λ<1, Xᵢ denotes a n×n positive definite matrix, and Yᵢ denotes a m×n matrix.

$$\begin{matrix}[ Math 28 ] & \\ [ \begin{matrix}{λ}^{2} {X}_{i} & {{p}_{i 1} [ {H}_{A 1}^{′} {X}_{i} + {H}_{B 1}^{′} {Y}_{i} ]}^{T} & {{p}_{i 2} [ {H}_{A 2}^{′} {X}_{i} + {H}_{B 2}^{′} {Y}_{i} ]}^{T} & ⋯ & {{p}_{iN} [ {H}_{AN}^{′} {X}_{i} + {H}_{BN}^{′} {Y}_{i} ]}^{T} \\ {{p}_{i 1} [ {H}_{A 1}^{′} {X}_{i} + {H}_{B 1}^{′} {Y}_{i} ]}^{T} & {p}_{i 1} {X}_{1} ⊗ {I}_{n 1} & {0}_{n 1 \cdot n \times n 2 \cdot n} & ⋯ & {0}_{n 1 \cdot n \times nN \cdot n} \\ {{p}_{i 2} [ {H}_{A 2}^{′} {X}_{i} + {H}_{B 2}^{′} {Y}_{i} ]}^{T} & {0}_{n 2 \cdot n \times n 1 \cdot n} & {p}_{i 2} {X}_{2} ⊗ {I}_{n 2} & ⋯ & {0}_{n 2 \cdot n \times nN \cdot n} \\ ⋮ & ⋮ & ⋮ & ⋱ & ⋮ \\ {{p}_{iN} [ {H}_{AN}^{′} {X}_{i} + {H}_{BN}^{′} {Y}_{i} ]}^{T} & {0}_{nN \cdot n \times n 2 \cdot n} & {0}_{nN \cdot n \times n 2 \cdot n} & ⋯ & {p}_{iN} {X}_{N} ⊗ {I}_{nN}\end{matrix} ] \geq 0 ( i = 1 , … , N ) & ( 28 )\end{matrix}$$

Particularly, Fᵢ=YᵢXᵢ⁻¹ is one of the design variables. Each of H′_{Aj} and H′_{Bj} is a matrix similarly obtained by Method 2.

Equation (28) is an LMI in which the modes 1 to N are simultaneous, and can be solved similarly by Method 2 in which no mode is used.

The present disclosure describes the method of designing the control gain through the three methods. The other conceivable methods include a method using both of the current mode and the past mode, and are available.

The conventional methods in each of which a target is deterministic have derived various LMIs including H2 performance and H∞ performance. Solving an LMI using Equation (22) and Equation (28) in combination, depending on each purpose can design a multi-use control gain such as designing a control gain that satisfies the H2 performance and the H∞ performance, while achieving the second-moment exponential stability.

In Non-Patent Documents 1 and 2, the second-moment exponential stability is calculated under a hypothesis that an absolute value of each of elements of A (ξₖ) and B (ξₖ) is lower than or equal to a certain value, besides the hypothesis of Equation (4). When it is assumed that the output distribution of each of the modes in the HMM has upper and lower limit values, the control gain can be designed under such a hypothesis. This can produce an advantage of simply designing the control gain with the conditions excluding calculation of an expected value.

### [Remotely Controlling Mobile Object]

Next, a method of remotely controlling a mobile object will be described in consideration of the aforementioned method of designing the control gain. FIG. 16 is a block diagram illustrating an example control system that controls a control target under the transmission latency environment including the remote control apparatus 1000 according to Embodiment 1, that is, the first mobile object 100. In FIG. 16, solid lines represent input and output of signals represented by continuous values, broken lines represent input and output of signals represented by discrete values, and x_{c} and u_{c} denote a state and an input, respectively, in a continuous time. Since the mobile object information on the first mobile object 100 obtained by each of various sensors is a discrete value, the mobile object information corresponds to an output value of a sampler S. The mobile object information is transmitted to the remote control apparatus 1000 through the network NW. At this moment, a transmission latency, that is, an upload transmission latency D_{UP} occurs herein. The mobile object information is delayed by this upload transmission latency D_{UP}, and is input to a controller ψ. The controller ψ outputs a controlled amount computed using a control gain, based on the mobile object information. This controlled amount corresponds to a controlled amount output by the controlled amount computation unit 312 of the first mobile object control unit 1031. The controlled amount is transmitted to the first mobile object 100 through the network NW. At this moment, a transmission latency, that is, a download transmission latency D_{dw} occurs herein. The controlled amount to be input to the first mobile object 100 at a certain time is kept at a constant value by a holder H until the next input. In other words, the holder H has a zero-order hold function. The zero-order held controlled amount is input to the first mobile object 100 that is a control target Pc.

Since the control system in FIG. 16 is a closed-loop system, ensuring the control stability requires setting a control gain in consideration of transmission latencies, that is, the upload transmission latency and the download transmission latency, and computing a controlled amount. Hereinafter, a control target of which transmission latencies are represented by a probability distribution will be described. First, a continuous-time state equation of the control target Pc is represented by Equation (29) below.

$$\begin{matrix}[ Math 29 ] & \\ {x}_{{c}^{*}} = {A}_{c} {x}_{c} ( t ) + {B}_{c} {u}_{c} ( t ) & ( 29 )\end{matrix}$$

Here, x_{c} and u_{c} denote a state and an input, respectively, in a continuous time. x_{C}⋅ denotes time derivation of x_{c}. Hereinafter, ⋅ denotes time derivation. The sampler S and the holder H in FIG. 16 are a sampler and a zero-order holder, respectively, which operate at a sampling time tₖ that satisfies Equation (30) below.

$$\begin{matrix}[ Math 30 ] & \\ {t}_{0} = 0 , {t}_{k + 1} - {t}_{k} > 0 , {lim}_{k \to ∞} {t}_{k} = ∞ & ( 30 )\end{matrix}$$

Assuming a sampling interval to be hₖ=tₖ₊₁−tₖ, hₖ becomes inconstant and aperiodic sampling in the network control system as illustrated in FIG. 16. The upload transmission latency D_{UP} and the download transmission latency D_{dw} in FIG. 16 are delay elements that delay arrival from a transmission source to a transmission destination by times τᵤₖ and τ_{dk} at each time k.

The stochastic process ξ that follows, for example, the HMM is considered. Assuming ξ=[ξᵤₖ, ξ_{dk}], a transmission latency is represented by Equation (31) below, using a constant εᵤ>0 and a constant ε_{d}>0.

$$\begin{matrix}[ Math 31 ] & \\ {τ}_{uk} = {ξ}_{uk} + {ϵ}_{u} , {τ}_{dk} = {ξ}_{dk} + {ϵ}_{d} & ( 31 )\end{matrix}$$

Here, the sampling interval hₖ is represented by Equation (32) below.

$$\begin{matrix}[ Math 32 ] & \\ {h}_{k} = {τ}_{uk} + {τ}_{dk} = {ξ}_{uk} + {ξ}_{dk} + {ϵ}_{u} + {ϵ}_{d} & ( 32 )\end{matrix}$$

Here, εᵤ and ε_{d} are transmission latencies physically determined, except transmission latencies that stochastically vary.

Equation (29) is converted into a discrete time state equation as indicated by Equation (33) below by the sampler S and the holder H in FIG. 16.

$$\begin{matrix}[ Math 33 ] & \\ {x}_{k + 1} = {A}_{k} {x}_{k} + {B}_{k} {u}_{k - 1} & ( 33 )\end{matrix}$$

Here, a relationship between a continuous signal and a discrete signal is represented by Equation (34) below.

$$\begin{matrix}[ Math 34 ] & \\ {x}_{k} = {x}_{c} ( {t}_{k} ) , {u}_{c} ( t ) = {u}_{k - 1} ( t ∈ [ {t}_{k} , {t}_{k + 1} ) ) & ( 34 )\end{matrix}$$

Here, Aₖ and Bₖ are given by Equation (35) below.

$$\begin{matrix}[ Math 35 ] & \\ {A}_{k} = {e}^{{A}_{c} {h}_{k}} , {B}_{k} = {\int }_{0}^{{h}_{k}} {e}^{{A}_{c} t} {B}_{c} dt & ( 35 )\end{matrix}$$

Here, Aₖ and Bₖ form a random matrix depending on ξₖ. Since the control input is not uₖ but uₖ₋₁ in Equation (33), uₖ to be determined according to xₖ cannot be obtained as an input at the time k. Thus, an extended system represented by Equation (36) below to which a new state x_{e, k} has been added is used.

$$\begin{matrix}[ Math 36 ] & \\ {x}_{e , k + 1} = {A}_{e} {x}_{e , k} + {B}_{e} {u}_{k} , {x}_{e , k} = [ \begin{matrix}{x}_{k} \\ {x}_{0 k}\end{matrix} ] \\ {A}_{e} = [ \begin{matrix}{A}_{k} & {B}_{k} \\ 0 & 0\end{matrix} ] , B = [ \begin{matrix}0 \\ I\end{matrix} ] & ( 36 )\end{matrix}$$

Here, the aforementioned method of designing the control gain can be applied by reading Equation (36) obtained herein as Equation (15) and modeling hₖ using a time-changed probability distribution such as the HMM.

### [When Mobile Object is Vehicle]

When a mobile object is a vehicle, a continuous-time state equation as indicated by Equation (29) is obtained per dynamics of the mobile object. The present disclosure provides a remote control apparatus that can be used for various mobile objects. Here, a case where the mobile object is a vehicle will be described as an example in detail. Many methods of controlling mobile objects have been proposed. The present disclosure describes the method by decomposing motion into motion in a lateral direction and motion in a forward and backward direction and controlling each of the directions.

First, a state equation representing dynamics in the lateral direction of the mobile object will be described with reference to FIG. 17. FIG. 17 illustrates a target path TR when the first mobile object 100 is a vehicle, that is, an example sequence of positions in a target trajectory. The target path TR is represented by an absolute coordinate system with X- and Y-axes. e_{y} and e_{θ} denote a lateral deviation and an angle of deviation, respectively, of the first mobile object 100 with respect to the target path TR.

Here, a state equation in the lateral direction of the first mobile object 100 is represented by Equation (37) below,

$$\begin{matrix}[ Math 37 ] & \\ \frac{d}{dt} [ \begin{matrix}{e}_{y} \\ {e}_{{y}^{*}} \\ {e}_{θ} \\ {e}_{{θ}^{*}}\end{matrix} ] = [ \begin{matrix}0 & 1 & 0 & 0 \\ 0 & - \frac{2 {C}_{f} + 2 {C}_{r}}{{mv}_{x}} & \frac{2 {C}_{f} + 2 {C}_{r}}{m} & \frac{- 2 {C}_{f} {L}_{f} + 2 {C}_{r} {L}_{r}}{{mv}_{x}} \\ 0 & 0 & 0 & 1 \\ 0 & - \frac{2 {C}_{f} {L}_{f} - 2 {C}_{r} {L}_{r}}{{I}_{z} {v}_{x}} & \frac{2 {C}_{f} {L}_{f} - 2 {C}_{r} {L}_{r}}{{I}_{z}} & - \frac{2 {C}_{f} {L}_{f}^{2} + 2 {C}_{r} {L}_{r}^{2}}{{I}_{z} {v}_{x}}\end{matrix} ] [ \begin{matrix}{e}_{y} \\ {e}_{{y}^{*}} \\ {e}_{θ} \\ {e}_{{θ}^{*}}\end{matrix} ] + [ \begin{matrix}0 \\ \frac{2 {C}_{f}}{m} \\ 0 \\ \frac{2 {C}_{f} {l}_{f}}{{I}_{z}}\end{matrix} ] δ & ( 37 )\end{matrix}$$

vₓ: a vehicle speed [m/s]
δ: a steering angle [rad]
m: a mass [kg]
L_{f}: a distance between the center of gravity and a front wheel axle [m]
Lᵣ: a distance between the center of gravity and a rear wheel axle [m]
I_{z}: a moment of inertia around a yaw axle [kg·m²]
C_{f}: a front wheel cornering stiffness [N/rad]
Cᵣ: a rear wheel cornering stiffness [N/rad]
e_{y}: a lateral deviation from the center of gravity of a vehicle to a target path [m]
e_{θ}: an angle of deviation from the center of gravity of the vehicle to the target path [rad]
e_{y}⋅: time derivation on the lateral deviation of a mobile object
e_{θ}⋅: time derivation on the angle of deviation of the mobile object

A cornering stiffness is a factor of proportionality representing a relationship between a lateral force and a side slip angle which are generated in a mobile object, and is, for example, a value that is changed according to a state of a contact surface between the mobile object and a road surface, such as a dry surface, a wet surface, and an icy surface.

A continuous-time state equation can be represented by Equation (38) below by describing Equation (37) similarly to Equation (29).

$$\begin{matrix}[ Math 38 ] & \\ \begin{matrix}{x}_{c} = {[ \begin{matrix}{e}_{y} & {e}_{{y}^{*}} & {e}_{θ} & {e}_{{θ}^{*}}\end{matrix} ]}^{T} \\ {A}_{c} := [ \begin{matrix}0 & 1 & 0 & 0 \\ 0 & - \frac{2 {C}_{f} + 2 {C}_{r}}{{mv}_{x}} & \frac{2 {C}_{f} + 2 {C}_{r}}{m} & \frac{- 2 {C}_{f} {L}_{f} + 2 {C}_{r} {L}_{r}}{{mv}_{x}} \\ 0 & 0 & 0 & 1 \\ 0 & - \frac{2 {C}_{f} {L}_{f} - 2 {C}_{r} {L}_{r}}{{I}_{z} {v}_{x}} & \frac{2 {C}_{f} {L}_{f} - 2 {C}_{r} {L}_{r}}{{I}_{z}} & - \frac{2 {C}_{f} {L}_{f}^{2} + 2 {C}_{r} {L}_{r}^{2}}{{I}_{z} {v}_{x}}\end{matrix} ] \\ {B}_{c} = [ \begin{matrix}0 \\ \frac{2 {C}_{f}}{m} \\ 0 \\ \frac{2 {C}_{f} {l}_{f}}{{I}_{z}}\end{matrix} ]\end{matrix} & ( 38 )\end{matrix}$$

The mobile object can follow a target path by controlling the mobile object such that e_{y}, e_{θ}, e_{y}⋅, and e_{θ}⋅ become 0 using this continuous-time state equation.

A state equation of the first mobile object 100 in a forward and backward direction can be modeled as indicated by, for example, Equation (39) below using an acceleration ax in the forward and backward direction, by modeling a state equation from a target acceleration uₐ to a vehicle speed vₓ as a first-order lag system of a time constant Tₐ.

$$\begin{matrix}[ Math 39 ] & \\ \frac{d}{dt} [ \begin{matrix}{v}_{x} \\ {a}_{x}\end{matrix} ] = [ \begin{matrix}0 & 1 \\ 0 & - 1 / {T}_{a}\end{matrix} ] [ \begin{matrix}{v}_{x} \\ {a}_{x}\end{matrix} ] + [ \begin{matrix}0 \\ 1 / {T}_{a}\end{matrix} ] {u}_{a} & ( 39 )\end{matrix}$$

Equation (39) can be a regulator problem by introducing Equation (39) as a reference model for setting a desirable response when a target acceleration is given, and by constructing a state equation using a deviation from the reference model as a state. With this, the control gain F with which the state can converge to 0 can be designed by the method of the present disclosure.

### [Control Feasibility Determination Unit]

There may be no control gain F with which the second-moment exponential stability is satisfied. In such a case, there is a possibility that unexpected transmission latencies occur, and the control stability of the mobile object cannot be guaranteed. Thus, the control feasibility determination unit 314 (FIG. 3) determines whether to stop controlling the mobile object, when the control stability of the mobile object cannot be guaranteed and the transmission latencies exceed a predetermined value. Consequently, when the unexpected transmission latencies occur, the control on the mobile object is stopped, and the control stability of the mobile object can be guaranteed.

The control feasibility determination unit 314 determines whether each LMI includes a solution to determine whether a closed-loop system is second-moment exponentially stable. Alternatively, when transmission latencies that cannot be modeled by the HMM occur, the control feasibility determination unit 314 determines, for example, to stop the control.

### Embodiment 2

### [Overall Configuration]

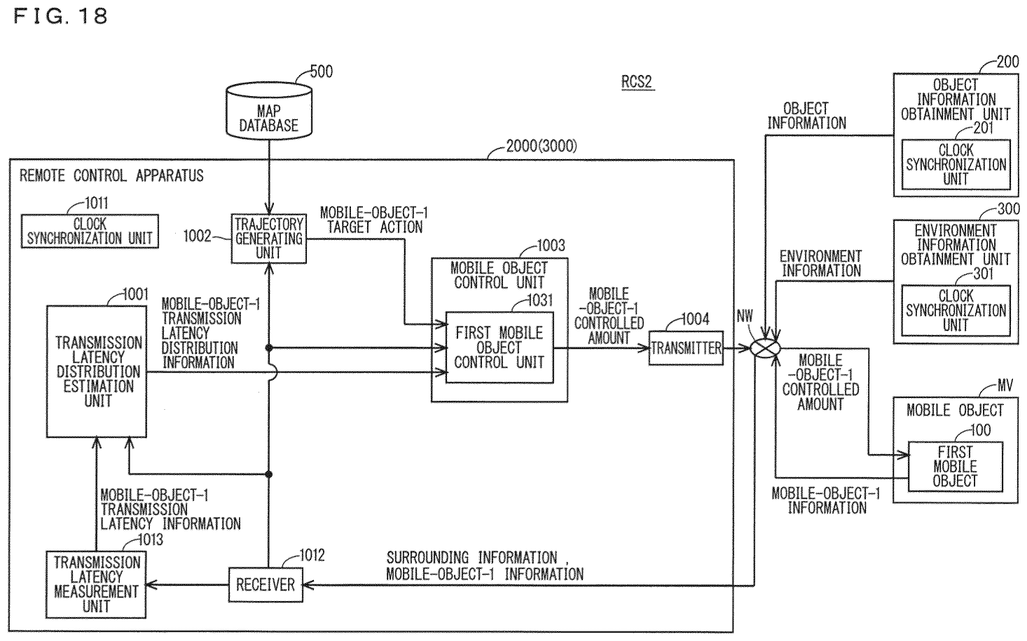

FIG. 18 is a block diagram illustrating an example configuration of a remote control apparatus 2000, and a configuration of a remote control system RCS2 for the mobile object MV to be remotely controlled through the network NW, in Embodiment 2 according to the present disclosure.

As illustrated in FIG. 18, the remote control apparatus 2000 of the remote control system RCS2 has a configuration in which the transmission latency distribution estimation unit 1001 uses the surrounding information and the mobile-object-1 information from the receiver 1012 and the map data from the map database 500 as inputs, when compared to the remote control apparatus 1000 in FIG. 1. Since the others are identical to those of the remote control apparatus 1000, the overlapping description will be omitted.

Although FIG. 18 illustrates a configuration for controlling only the first mobile object 100 to facilitate the description, a configuration similar to that of FIG. 2 can be applied to two or more mobile objects. Here, the transmission latency distribution estimation unit 1001 receives mobile object information on the two or more mobile objects from the receiver 1012, and outputs the transmission latency distribution information on each of the mobile objects to the mobile object control unit 1003.

When considering that the mobile objects have almost equivalent network environment and surrounding circumstances, and have almost the same tendency in transmission latency, the transmission latency distribution estimation unit 1001 equates transmission latencies of a plurality of mobile objects, and simplifies the computation.

### [Transmission Latency Distribution Estimation Unit]

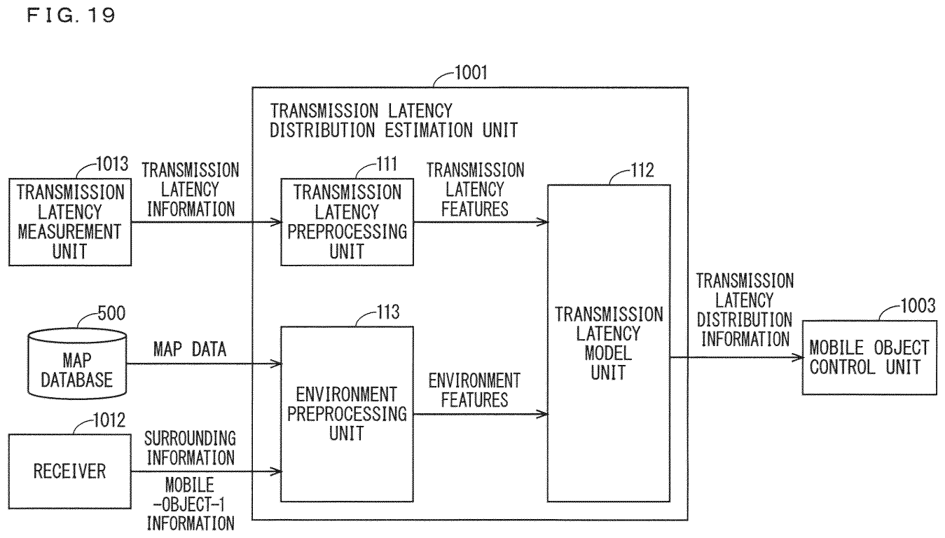

FIG. 19 is a block diagram illustrating an example configuration of the transmission latency distribution estimation unit 1001. In this example, the transmission latency distribution estimation unit 1001 includes the transmission latency preprocessing unit 111, the transmission latency model unit 112, and an environment preprocessing unit 113.

The transmission latency preprocessing unit 111 has a function of transforming the transmission latency information from the transmission latency measurement unit 1013 into transmission latency features to be referred to by the transmission latency model unit 112.

The transmission latency model unit 112 has been modeled in advance using the transmission latency features calculated by the transmission latency preprocessing unit 111, and computes the transmission latency distribution information with reference to the transmission latency features and environment features.

The environment preprocessing unit 113 calculates features on environment information except the transmission latency information. In other words, the environment preprocessing unit 113 has a function of computing environment features that characterize an environment, from the map data from the map database 500 and the mobile-object-1 information and the surrounding information from the receiver 1012. Since the transmission latency preprocessing unit 111 and the transmission latency features are identical to those according to Embodiment 1, the description will be omitted.

The transmission latency features are directly obtained from a sequence of transmission latencies, whereas the environment features representing surrounding circumstances of a mobile object are computed from physically measurable values including the current time, a radio wave condition around the mobile object, the presence or absence of a surrounding structure, a distance between the surrounding structure and the mobile object, a conductor around the mobile object, an obstacle, field intensity, and traffic. The environment preprocessing unit 113 computes the environment features, using the map data, the mobile object information, and the surrounding information.

For example, if a building is located near a mobile object, the position of the building can be detected from the map data, and the position of the mobile object can be detected from the GNSS. Thus, the relative distance between the building and the mobile object can be converted into numbers, which will be used as an environment feature. Since, for example, the field intensity can be detected from an antenna and a receiver, the field intensity can be used as an environment feature.

Advantages of having such a configuration will be described. As previously described, how the transmission latency varies is changed according to switching between transmission paths. Besides, the transmission latency may occur due to load conditions on the network NW, such as a condition of a line user, traffic, and characteristics of a router. Since a mobile object moves, the transmission latency may occur due to influences such as the presence or absence of an obstacle on a radio propagation route, jamming, and the presence or absence of a conductor around the mobile object. The confluence of these factors probably produces the final transmission latency.

Inputting the environment features representing such circumstances into a transmission latency model can create a transmission latency model with higher accuracy, and estimate the transmission latency distribution.

The transmission latency model in Embodiment 2 is structured, specifically, such that the transition probability between modes represented by pᵢⱼ (i=1, 2, 3, 4, j=1, 2, 3, 4) in FIG. 15 is changed according to the environment features. For example, when a mobile object moves in a place with many structures around, for example, a building, by which radio waves are refracted or blocked, the transition probability is increased so that the mobile object easily transitions to a mode of larger transmission latencies. Alternatively, since traffic decreases at nighttime, modeling, such as reducing a transition probability to prevent the mobile object from transitioning to the mode of larger transmission latencies is conceivable. Under such a structure, a control gain using a transition probability as a parameter can be designed.

### Embodiment 3

### [Transmission Latency Distribution Estimation Unit]

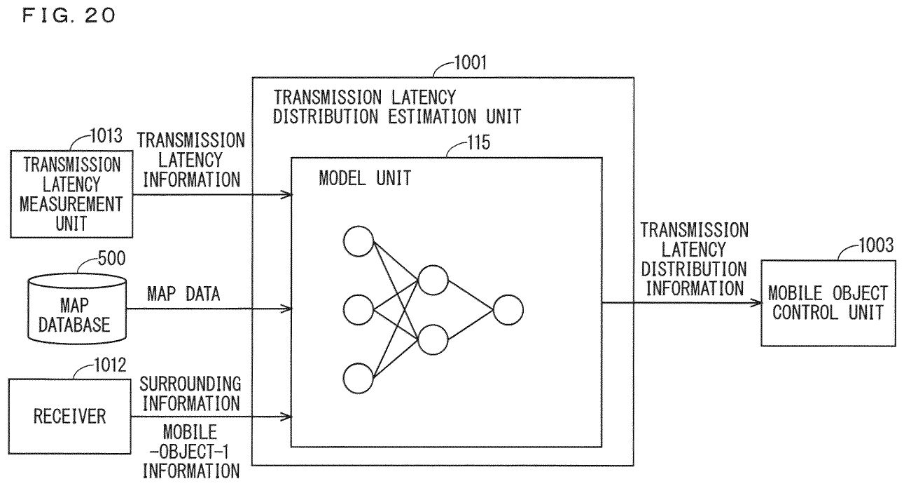

FIG. 20 is a block diagram illustrating an example configuration of the transmission latency distribution estimation unit 1001 of a remote control apparatus 3000 in Embodiment 3 according to the present disclosure. In this example, the transmission latency distribution estimation unit 1001 includes a model unit 115. Since the configurations except the transmission latency distribution estimation unit 1001 are identical to those of the remote control apparatus 2000 according to Embodiment 2 in FIG. 18, the overlapping description will be omitted assuming that the overall configurations are identical to those in FIG. 18.

Upon receipt of the transmission latency information from the transmission latency measurement unit 2013, the map data from the map database 500, and the surrounding information and the mobile-object-1 information which have been obtained through the network NW, the model unit 115 computes the transmission latency distribution information through machine learning.

In recent years, technologies on machine learning using artificial intelligence (AI) with deep learning technology at the top have significantly been advanced.

Embodiment 3 provides a method of designing a control gain and a method of estimating the transmission latency distribution information online, by learning a transmission latency model through the technologies on machine learning, and using the obtained learned model. This produces the transmission latency model with high accuracy, and the transmission latency distribution information online.

The transmission latency distribution estimation unit 1001 in FIG. 20 is configured to output the transmission latency distribution information online, using the learned model that has been learned through machine learning. When learning the transmission latency model, first, the transmission latency distribution estimation unit 1001 needs to obtain learning data. To obtain the learning data, the transmission latency distribution estimation unit 1001 obtains the mobile-object-1 transmission latency information from the transmission latency measurement unit 1013, and the surrounding information and the mobile object information which have been obtained through the network NW, and stores such pieces of information as data sets while the first mobile object 100 is moving. The model unit 115 can be learned using the stored data sets and the map database 500.

Learning methods using the transmission latency model as an HMM model have been researched well mainly in the speech recognition field. The HMM model can be learned using the methods. When learning a more typical transmission latency model is desired, learning using a machine teaming method with long-short time memory (LSTM) in which a time series is learned is possible.

The transmission latencies can include at least an amount of transmission latencies, an average value of transmission latencies in a predefined time segment, variance of transmission latencies, or the maximum value or the minimum value of transmission latencies.

The surrounding information can include at least the time, a radio wave condition around a mobile object, the presence or absence of a structure around the mobile object, a distance between the structure and the mobile object, a conductor and an obstacle around the mobile object, field intensity, weather, and traffic.

The map data can include at least a shape of a road around the mobile object, and a position and a shape of a surrounding structure.

In the machine learning, learning is possible if there is a correlation between an input and an output. Thus, inputting the transmission latency features, the environment features, and the map data into the model unit 115 allows output of the transmission latency distribution information. For example, “Speech recognition system using free software (2nd edition)”, Masahiro Araki (author), MORIKITA PUBLISHING CO., LTD. discloses an HMM learning method through deep learning.

### [Modifications]

Although the HMM described in Embodiments 1 to 3 is a non-hierarchical hidden Markov model, for example, a hierarchical hidden Markov model in which the HMM has been hierarchically organized can be used as a more precise transmission latency model. Both of the non-hierarchical hidden Markov model and the hierarchical hidden Markov model can predict transmission latencies with high accuracy.

Conceivable examples of probability distributions followed by transmission latencies include a class of a martingale. The martingale is a class in which an expected value at the current time matches an occurrence at a previous time. Non-Patent Document 1 describes stable conditions on the class of the martingale. Using this, the control gain can be designed.

Furthermore, the present disclosure describes a method of evaluating the stability using the second-moment exponential stability. Although the second-moment exponential stability is an indicator of the strongest stability, the other stabilities can be similarly used.

As described by the operations of the sampler S and the holder H in FIG. 16, the present disclosure describes a basic configuration of the remote control apparatus and a mobile object such that upon receipt of a signal, the next signal is immediately transmitted to a partner. In this configuration, however, when transmission latencies are very small, the sampling interval becomes too short for responsiveness of the mobile object that is a control target, and traffic of a network may unnecessarily increase. This problem can be addressed by artificially setting a minimum delay time in advance based on, for example, the responsiveness of the mobile object, and transmitting a signal when the set minimum delay time falls below actual communication delay. The signal is transmitted after the mobile object or the remote control apparatus waits until a time corresponding to the set minimum delay time has elapsed.

For example, when the minimum delay is defined as 50 m sec and a transmission latency shorter than or equal to 50 m sec occurs, the mobile object or the remote control apparatus waits until 50 m sec including the transmission latency has elapsed, and then transmits a signal. This can always create a situation in which the sampling interval is always longer than or equal to 50 m sec. Both of the mobile object or the remote control apparatus can perform this wait.

The control with which the problem has been addressed can be performed, by designing a control gain based on the transmission latencies with a premise of addressing the problem. Although the minimum delay can be a fixed value, the minimum delay can vary based on information on actual transmission latencies.

For example, the minimum delay can be switched for each mode of the transmission latencies, or vary according to the time and the surrounding information.

Although the present disclosure simply describes that, for example, a computation time in the remote control apparatus is negligible, when the computation time is not negligible, the remote control apparatus can include the computation time in the transmission latencies, and handle the computation time. When the minimum delay is set as described above, the wait time can be used in a certain computation.

### [Hardware Configuration]

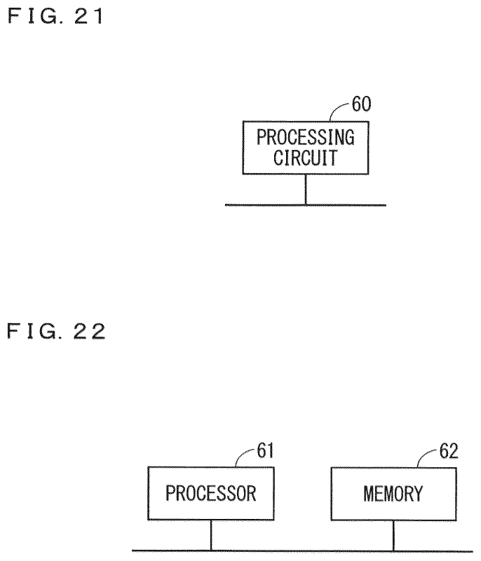

Each of the constituent elements of the remote control apparatuses 1000 to 3000 according to Embodiments 1 to 3 can be configured using a computer, and is implemented by causing the computer to execute a program. In other words, the remote control apparatuses 1000 to 3000 can be implemented by, for example, a processing circuit 60 illustrated in FIG. 21. A processor such as a central processing unit (CPU) or a digital signal processor (DSP) is applied to the processing circuit 60. The processing circuit 60 causes the program stored in a storage to implement functions of each of the constituent elements.

The processing circuit 60 may be dedicated hardware. When the processing circuit 60 is dedicated hardware, it corresponds to, for example, a single circuit, a composite circuit, a programmed processor, a parallel-programmed processor, an application-specific integrated circuit (ASIC), a field-programmable gate array (FPGA), or any combinations thereof.

Each function of the constituent elements of the remote control apparatuses 1000 to 3000 can be implemented by a separate processing circuit, or the functions may be collectively implemented by a single processing circuit.

FIG. 22 illustrates a hardware configuration when the processing circuit 60 is configured using a processor. In this case, the functions of the constituent elements of the remote control apparatuses 1000 to 3000 are implemented by any combinations with software, etc. (software, firmware, or the software and the firmware). For example, the software is described as a program, and stored in a memory 62. A processor 61 functioning as the processing circuit 60 implements the functions of each of the constituent elements by reading and executing the program stored in the memory 62 (a storage). In other words, this program causes a computer to execute procedures and methods of operations of the constituent elements of the remote control apparatuses 1000 to 3000.

Here, examples of the memory 62 include a non-volatile or volatile semiconductor memory such as RAM, ROM, a flash memory, an erasable programmable read-only memory (EPROM), and an electrically erasable programmable read-only memory (EEPROM), hard disk drive (HDD), a magnetic disk, a flexible disk, an optical disk, a compact disc, a minidisc, a Digital Versatile Disc (DVD), a drive device thereof, and further any storage medium to be used in the future.

What is described is that, for example, one of hardware and software implements the functions of each of the constituent elements of the remote control apparatuses 1000 to 3000. However, the configuration is not limited to such but part of the constituent elements of the remote control apparatuses 1000 to 3000 can be implemented by dedicated hardware, and another part thereof can be implemented by software. For example, the processing circuit 60 functioning as the dedicated hardware can implement the part of the constituent elements, and the processing circuit 60 functioning as the processor 61 can implement the functions of another part of the constituent elements through reading and executing a program stored in the memory 62.

As described above, the remote control apparatuses 1000 to 3000 can implement each of the functions by hardware, software, etc., or any combinations of these.

Although the present disclosure is described in detail, the foregoing description is in all aspects illustrative and does not restrict the present disclosure. It is therefore understood that numerous modifications and variations that have not yet been exemplified can be devised without departing from the scope of the present disclosure.

Embodiments of the present disclosure can be freely combined, and appropriately modified or omitted within the scope of the disclosure.

1.-15. (canceled)

16. A remote control apparatus controlling at least one mobile object through a transmission path including at least a network, the apparatus comprising:
transmission latency distribution estimation circuitry to estimate transmission latency distribution information based on transmission latency information of the transmission path obtained in advance and transmission latency information obtained online, the transmission latency distribution information including a time-changed probability distribution of transmission latencies;
trajectory generating circuitry to generate a target trajectory of the at least one mobile object, based on surrounding information around the at least one mobile object; and
mobile object control circuitry to generate a controlled amount of the at least one mobile object, based on the transmission latency distribution information obtained from the transmission latency distribution estimation circuitry, the target trajectory obtained from the trajectory generating circuitry, and mobile object information obtained from the at least one mobile object,
wherein the mobile object control circuitry includes:
gain setting circuitry to set a control gain, based on the transmission latency distribution information; and
controlled amount computation circuitry to generate the controlled amount, based on the target trajectory, the control gain, and the mobile object information.

17. The remote control apparatus according to claim 16,
wherein the transmission latency distribution estimation circuitry estimates the transmission latency distribution information, based on the pieces of transmission latency information and environment features around the at least one mobile object.

18. The remote control apparatus according to claim 16,
wherein the transmission latency distribution estimation circuitry estimates the transmission latency distribution information, based on a model of the transmission latencies learned through machine learning.

19. The remote control apparatus according to claim 16,
wherein the mobile object information includes a state quantity of the at least one mobile object which has been obtained by a sensor,
the mobile object control circuitry includes
mobile object estimation circuitry to estimate a coefficient distribution that is a probability distribution of coefficients for the state quantity, and
the gain setting circuitry sets the control gain, based on the transmission latency distribution information and the coefficient distribution.

20. The remote control apparatus according to claim 16,
wherein the transmission latency distribution estimation circuitry models the time-changed probability distribution, using a hierarchical or non-hierarchical hidden Markov model.

21. The remote control apparatus according to claim 16,
wherein the mobile object control circuitry includes
control feasibility determination circuitry to determine whether to continue to control or stop controlling the at least one mobile object, based on the transmission latency distribution information, and
the control feasibility determination circuitry determines to stop controlling the at least one mobile object, when the transmission latencies exceed a predetermined value and control stability of the at least one mobile object cannot be guaranteed.

22. The remote control apparatus according to claim 16,
wherein the at least one mobile object comprises a plurality of mobile objects, and
the trajectory generating circuitry generates the target trajectory of each of the plurality of mobile objects.

23. The remote control apparatus according to claim 22,
wherein when equating respective pieces of the transmission latency distribution information of the plurality of mobile objects, the transmission latency distribution estimation circuitry groups the plurality of mobile objects, and estimates a common probability distribution of the transmission latencies using one of the pieces of the transmission latency distribution information.

24. The remote control apparatus according to claim 16,
wherein upon receipt of a signal in less than a minimum delay time set in advance, the gain setting circuitry sets the control gain, based on the transmission latency distribution information that considers the minimum delay time, and transmits the controlled amount after a lapse of the minimum delay time.

25. A remote control apparatus controlling at least one mobile object through a transmission path including at least a network, the apparatus comprising:
transmission latency distribution estimation circuitry to estimate transmission latency distribution information based on transmission latency information of the transmission path obtained in advance and transmission latency information obtained online, the transmission latency distribution information including a probability distribution of transmission latencies and a current mode or a past mode of the transmission latencies;
trajectory generating circuitry to generate a target trajectory of the at least one mobile object, based on surrounding information around the at least one mobile object; and
mobile object control circuitry to generate a controlled amount of the at least one mobile object, based on the transmission latency distribution information obtained from the transmission latency distribution estimation circuitry, the target trajectory obtained from the trajectory generating circuitry, and mobile object information obtained from the at least one mobile object,
wherein the mobile object control circuitry includes:
gain setting circuitry to set a control gain, based on the transmission latency distribution information; and
controlled amount computation circuitry to generate the controlled amount, based on the target trajectory, the control gain, and the mobile object information.

26. The remote control apparatus according to claim 25,
wherein the transmission latency distribution estimation circuitry estimates the transmission latency distribution information, based on the pieces of transmission latency information and environment features around the at least one mobile object.

27. The remote control apparatus according to claim 25,
wherein the transmission latency distribution estimation circuitry estimates the transmission latency distribution information, based on a model of the transmission latencies learned through machine learning.

28. The remote control apparatus according to claim 25,
wherein the mobile object information includes a state quantity of the at least one mobile object which has been obtained by a sensor,
the mobile object control circuitry includes
mobile object estimation circuitry to estimate a coefficient distribution that is a probability distribution of coefficients for the state quantity, and
the gain setting circuitry sets the control gain, based on the transmission latency distribution information and the coefficient distribution.

29. The remote control apparatus according to claim 25,
wherein the transmission latency distribution estimation circuitry models the probability distribution, using a hierarchical or non-hierarchical hidden Markov model.

30. The remote control apparatus according to claim 25,
wherein the mobile object control circuitry includes
control feasibility determination circuitry to determine whether to continue to control or stop controlling the at least one mobile object, based on the transmission latency distribution information, and
the control feasibility determination circuitry determines to stop controlling the at least one mobile object, when the transmission latencies exceed a predetermined value and control stability of the at least one mobile object cannot be guaranteed.

31. The remote control apparatus according to claim 25,
wherein the at least one mobile object comprises a plurality of mobile objects, and
the trajectory generating circuitry generates the target trajectory of each of the plurality of mobile objects.

32. The remote control apparatus according to claim 31,
wherein when equating respective pieces of the transmission latency distribution information of the plurality of mobile objects, the transmission latency distribution estimation circuitry groups the plurality of mobile objects, and estimates a common probability distribution of the transmission latencies using one of the pieces of the transmission latency distribution information.

33. The remote control apparatus according to claim 25,
wherein upon receipt of a signal in less than a minimum delay time set in advance, the gain setting circuitry sets the control gain, based on the transmission latency distribution information that considers the minimum delay time, and transmits the controlled amount after a lapse of the minimum delay time.

34. A method of remotely controlling at least one mobile object through a transmission path including at least a network, the method comprising:
estimating transmission latency distribution information based on transmission latency information of the transmission path obtained in advance and transmission latency information obtained online, the transmission latency distribution information including a time-changed probability distribution of transmission latencies;
generating a target trajectory of the at least one mobile object, based on surrounding information around the at least one mobile object;
generating a controlled amount of the at least one mobile object, based on a control gain set based on the transmission latency distribution information, the target trajectory, and mobile object information on the at least one mobile object; and
controlling the at least one mobile object based on the controlled amount.
